(19) United States
(12) Patent Application Publication
(10) Pub. No.: US 2012/0079100 A1
(43) Pub. Date: Mar. 29, 2012

(54) ELECTRONIC DEVICE DIAGNOSTIC SYSTEMS AND METHODS

(75) Inventors: William C. McIntyre, Lombard, IL (US); Martin J. Wisniewski, Elmhurst, IL (US); Christian T. Graham, Vernon Hills, IL (US); Jason Brooks, Lindenhurst, IL (US); David E. Meeker, Chicago, IL (US); Scott Judy, Chicago, IL (US); Zachary DeBord, Ann Arbor, MI (US); Mark Ferry, Chicago, IL (US); Chandrasekar Raju, Chicago, IL (US)

(73) Assignee: MOTOROLA MOBILITY, INC., Libertyville, IL (US)

(21) Appl. No.: 13/118,094

(22) Filed: May 27, 2011

Related U.S. Application Data
(60) Provisional application No. 61/349,731, filed on May 28, 2010.

(51) Int. Cl. G06F 15/16

(52) U.S. Cl. 709/224

(57) ABSTRACT

Embodiments of methods of evaluating a wireless communication device using a computing system are provided. The embodiments include establishing a data connection between the wireless communication device and the computing system, and receiving device-specific information associated with the wireless communication device. The device-specific information includes at least one identifier associated with the wireless communication device. The device-specific information is provided to a server over a network, and additional device-specific information associated with evaluating the wireless communication device is received in response to providing the device-specific information to the server. Finally, in response to receiving the additional device-specific information, diagnostic-related information and a representation of the additional device-specific information are displayed on the computing system.

### CROSS-REFERENCE TO RELATED APPLICATION

This application claims priority to U.S. provisional application No. 61/349,731, filed on May 28, 2010.

### TECHNICAL FIELD

The inventive subject matter generally relates to methods and apparatus for performing diagnostic procedures on electronic devices, and more particularly to methods and apparatus for performing diagnostic procedures on wireless communication devices in the context of service and repair activities.

### BACKGROUND

When a cellular telephone user experiences an operational problem with the user's telephone, he or she has several options for obtaining assistance in resolving the issue. For example, the user may consult the user's manual, contact a customer service call center to discuss the problem with a customer service representative, and/or attempt to locate diagnostic information online. Alternatively, the cellular telephone user may bring the telephone to a walk-in-service location, such as a retail store at which store personnel have particular expertise in diagnosing cellular telephone problems. In many cases, such diagnostic processes yield a solution to the problem, which can be implemented by the user, customer service representative, and/or retail store personnel.

At times, however, these diagnostic options fail to determine the problem, fail to provide a solution, or indicate that repair may be necessary to resolve the problem. In such cases, the cellular telephone may be shipped to a repair facility associated with a cellular carrier or an original equipment manufacturer (OEM). At the repair facility, skilled technicians may perform more comprehensive diagnostic procedures to attempt to diagnose the problem. When these procedures successfully indicate the problem, the repair facility personnel may implement a solution to repair the telephone, or may scrap the telephone and provide a replacement to the user when no reasonable solution is available.

In some cases, repair facility personnel may be unable to verify the reported problem with the telephone. Typically, such a telephone is designated as “no trouble found” (NTF) or “returned unrepaired” (RUR), and the telephone is shipped back to the user. In other cases, a determination may be made at the repair facility that the version of software on the telephone is incorrect or outdated. The repair facility personnel may update the software and ship the telephone to the user, in such a case, even though such a software update may have been easily performed at a walk-in-service location or through the internet. Typical percentage of telephones returned by a repair facility that are designated as NTF, RUR, or that merely required software updates can be in a range of about 10 to 40 percent of the telephones that are shipped to the repair facility. These potentially avoidable repair evaluations represent a significant financial cost to the industry and inconvenience to the owner who does not have the service of their telephone while it is in transit and being repaired. Accordingly, what are needed are methods and systems for better diagnosing operational problems with consumer electronic devices, and improving communications between the owner and the service technician diagnosing the electronic device, which may result in a reduction in the number of devices that are shipped to repair facilities with no actual problem, outdated software, or problems that may have been solvable by the user at home or at a walk-in-service location.

### BRIEF DESCRIPTION OF THE DRAWINGS

The inventive subject matter will hereinafter be described in conjunction with the following drawing figures, wherein like numerals denote like elements, and

FIG. 1 is a simplified diagram of a diagnostic system, in accordance with an example embodiment;

FIG. 2 is a simplified, conceptual diagram of various entities residing on or interacting with a client workstation in conjunction with performing diagnostic procedures for an electronic device, in accordance with an example embodiment;

FIG. 3 is a simplified, conceptual diagram of various software components and communications interfaces and protocols implemented within diagnostic system, in accordance with an example embodiment;

FIG. 4 is a simplified, conceptual diagram of a diagnostic system architecture, in accordance with another example embodiment;

FIG. 5 is a simplified, conceptual diagram of a diagnostic system architecture, in accordance with another example embodiment;

FIG. 6 is a simplified, conceptual diagram of a diagnostic system architecture, in accordance with another example embodiment;

FIG. 7 is a flowchart of a method for installing diagnostic functionality within a diagnostic system, in accordance with an example embodiment;

FIG. 8 is a simplified, conceptual diagram illustrating several of the major functionalities that may be provided by an SRTools application of a diagnostic system, in accordance with an example embodiment;

FIGS. 9 and 10 are more detailed, conceptual diagrams illustrating sequences of events that may be performed in conjunction with the end-to-end process of electronic device diagnosis and repair, in accordance with various embodiments;

FIG. 11 is a flowchart of a method for using a diagnostic system to implement device capture, diagnosis, and repair processes, in accordance with an example embodiment;

FIG. 12 is a conceptual diagram illustrating interaction between various system components in conjunction with a login process, in accordance with an example embodiment;

FIG. 13 is a conceptual diagram illustrating interaction between various system components in conjunction with performing version control for the client workstation SRTools application, in accordance with an example embodiment;

FIGS. 14 and 15 illustrate example screen shots that may be presented on a client workstation in conjunction with the connection process;

FIG. 16 illustrates an example screen shot that may be presented on a client workstation in conjunction with the complaint entry process, in accordance with an example embodiment;

FIGS. 17 and 18 are conceptual diagrams illustrating interaction between various system components in conjunction with a complaint entry process, in accordance with another example embodiment;

FIG. 19 illustrates an example screen shot that may be presented on a client workstation in conjunction with user-selectable device testing procedures, in accordance with an example embodiment;

FIG. 20 is a conceptual diagram illustrating interaction between various system components in conjunction with a triage process, in accordance with an example embodiment;

FIGS. 21 and 22 illustrate example screen shots that may be presented on a client workstation in conjunction with performing a software update process, in accordance with an example embodiment;

FIG. 23 is a conceptual diagram illustrating interaction between various system components in conjunction with a software update process, in accordance with an example embodiment;

FIGS. 24 and 25 illustrate example screen shots that may be presented on a client workstation in conjunction with retrieving information from a knowledge management system, in accordance with an example embodiment; and

FIGS. 26-31 are sequence diagrams illustrating interaction between various system components in conjunction with various aspects of a diagnostic process, in accordance with an example embodiment.

### DETAILED DESCRIPTION

The following detailed description of the inventive subject matter is merely exemplary in nature and is not intended to limit the inventive subject matter or the application and uses of the inventive subject matter. Furthermore, there is no intention to be bound by any theory presented in the preceding background or the following detailed description.

Embodiments include methods and apparatus for performing diagnostic procedures on electronic devices. The diagnostic procedures may be performed in the larger context of a system and business model directed toward implementing repairs and updates to an electronic device. Embodiments of the methods and apparatus for performing diagnostic procedures described herein may be referred to as “tools,” or more specifically, “service and repair tools” (abbreviated “SRTools,” for convenience). SRTools provided by a particular enterprise may be branded by that enterprise, in some cases. For example, an entity such as Motorola, Inc. of Schaumberg, Ill. may brand a version of an SRTools suite.

The various embodiments may enable operational problems with an electronic device to be identified and remedied earlier in the repair process (e.g., before shipping the device to a repair facility) than is typically possible using prior diagnostic techniques and systems. In addition, the various embodiments may enable device users (e.g., consumers), customer service representatives, and/or walk-in-service location personnel (e.g., a retail location) to more readily identify situations in which real or perceived operational problems may be resolved by user-performed actions and/or user education, as opposed to situations in which actual repairs (e.g., by trained repair facility personnel) are warranted. This may significantly reduce the quantity of devices that are sent to repair facilities, and more particularly, may significantly reduce the quantity of devices that are unnecessarily sent to repair facilities (e.g., devices which the repair facility would otherwise designate as NTF, RUR, or merely requiring software updates).

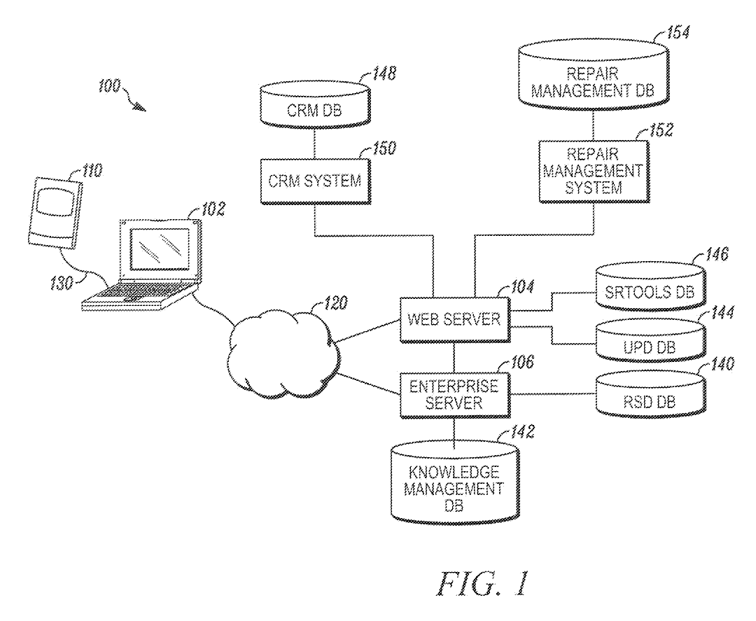

FIG. 1 is a simplified diagram of a diagnostic system 100, in accordance with an example embodiment. System 100 includes a client workstation 102 (also referred to as a “collection point” or “CP”), a web and application server 104 (also referred to as “web server”), and an enterprise server 106, in an embodiment. When an electronic device 110 (e.g., a device in need of diagnosis and possibly service and/or repair) establishes data communication with client workstation 102, various processes are performed by system 100 in the context of diagnosing operational problems with electronic device 110, providing useful information regarding perceived and actual operational problems and “fixes” for those problems, and/or supporting updates to the software of electronic device 110, among other things.

System 100 may be used to diagnose, test, and service various different types of electronic devices. For example, as shown in FIG. 1, electronic device 110 may be a wireless communication device, such as a cellular telephone. Alternatively, system 100 may be used to diagnose, test, and service other types of devices, including but not limited to computers, other wireless communication devices (e.g., personal data assistants (PDAs), radios, devices implementing the Bluetooth protocol, and so on), various consumer electronics (e.g., portable media players, televisions, set top boxes, gaming systems, appliances, and so on), computerized manufacturing and/or industrial equipment, and vehicular control systems (e.g., automotive, aircraft, and/or watercraft systems), to name a few examples. Although the various embodiments are described in detail herein as providing diagnosis, testing, and service for cellular telephones, it is to be understood that the scope of applicability for the inventive subject matter is not limited to application to cellular telephones. A matrix file may be stored on the electronic device 110 and/or on any of the system components, according to an embodiment. The matrix file may be used, for example, to determine availability of release notes, device testing functions, and backup and restore functions. Accordingly, the matrix file may include a device-specific group of tests, software programming flash file, and sequence and controls that may be evoked during the diagnostic and complaint resolution processes.

Client workstation 102 includes a computing system (e.g., a desktop computer, a laptop computer, a tablet computer, or another type of computing system), which includes at least a display and a user interface (e.g., keyboard, cursor control device, and so on). As will be indicated in various figures and their associated descriptions, below, client workstation 102 may provide a graphical user interface (GUI) via the display and user interface, which enables a system user easily to interact with the diagnostic system 100.

Client workstation 102 also includes apparatus for establishing a data connection with an electronic device (e.g., electronic device 110). For example, client workstation 102 may include a USB port, which may be connected to a data port of electronic device 110 via a USB connector 130. Alternatively, client workstation 102 may include a different type or data port for communications with electronic device 110, and/or may be configured to exchange data with electronic device 110 wirelessly (e.g., via a radio frequency (RF) communication link, including a link implementing a Near Field Communication (NFC), Bluetooth, or other wireless communication technology).

Client workstation 102 also includes apparatus for communicating with web server 104 and/or enterprise server 106 over a wired or wireless communications network 120, such as the Internet, a local area network, a wide area network, a cellular communications network, and so on. As will be explained in more detail below, client workstation 102 is configured to exchange information with web server 104 and enterprise server 106 during performance of various diagnostic procedures for electronic device 110. These diagnostic procedures may yield information at the client workstation 102 that enables the user, customer service representative, and/or walk-in-service location personnel to implement basic repair processes (e.g., including software updates) and/or to access information that illuminates situations in which user error may be a significant contributing factor for an operational problem.

Client workstation 102 may be referred to generally herein as a “service touchpoint,” because client workstation 102 may be implemented in various configurations relating to the diagnosis, service, and repair of electronic devices. For example, client workstation 102 may simply be a personal computer to which the user has access (e.g., at home or in the office). Alternatively, client workstation 102 may be implemented in a device service kiosk and/or a walk-in-service location (e.g., in a retail store location). Client workstation 102 also may be implemented in a repair facility, to which a user has shipped the electronic device.

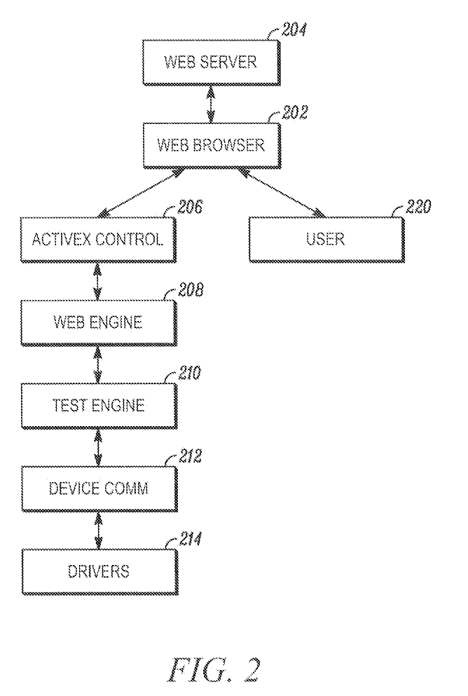

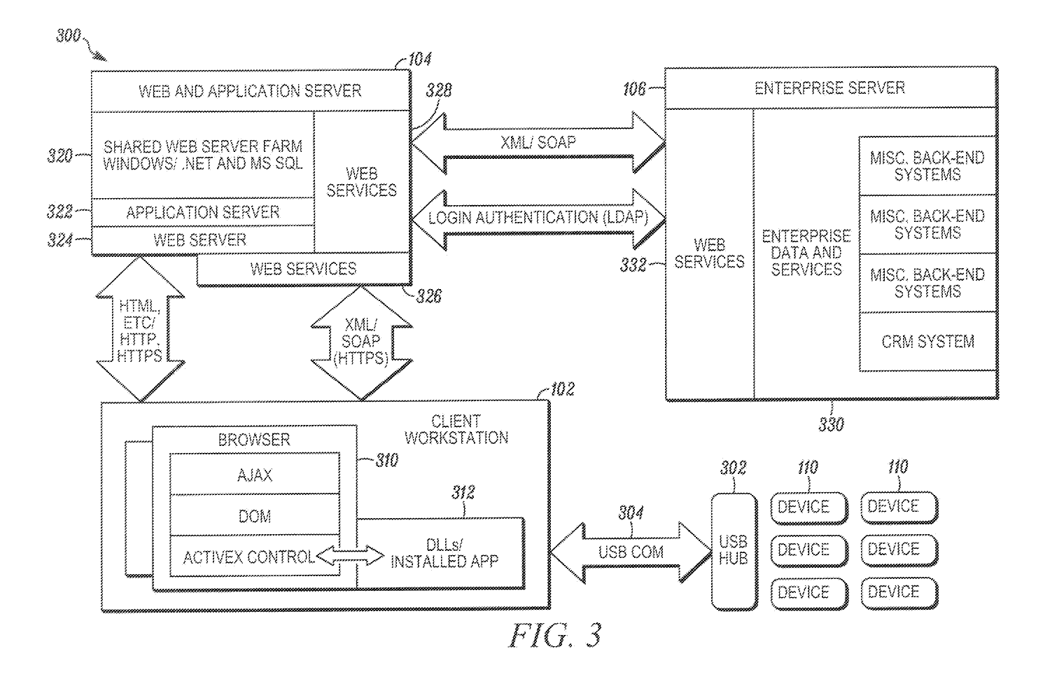

FIG. 2 is a simplified, conceptual diagram of various entities residing on or interacting with a client workstation (e.g., client workstation 102, FIG. 1) in conjunction with performing diagnostic procedures for an electronic device, in accordance with an example embodiment. Prior to performing the diagnostic procedures, various software components are installed on the client workstation, as will be described in more detail later. As used herein, the terms “native code” and “installed component(s)” mean software components that are installed and executed on the client workstation. As will be described in more detail later, native code includes software components that are native to the operating system of the client workstation, and may include installed applications (e.g., an SRTools application), drivers, dynamic link libraries (dlls), .ocx files, ActiveX controls, and other types of code (e.g., any type of compiled code). According to an embodiment, the native code includes, among other things, at least one software component that communicates with the electronic device, and at least one software component that communicates with a server (e.g., web server 204). Native code that executes/manages the device diagnostics with the electronic device is referred to herein as “native device diagnostics code” 208, 210, 212. Native code that communicates with the electronic device is referred to herein as “native device communication code” 214, and native code that communicates with a server is referred to herein as “native server communication code” 206.

In addition, web browser 202 also is installed on the client workstation, although neither web browser 202 nor any web pages interpreted and displayed by web browser 202 are considered to be “native code” or an “installed component” for the purposes of this description. At the behest of a user 220, the web browser 202 executes on the client workstation. More particularly, web browser 202 downloads and renders various web pages associated with the diagnostic procedures of the various embodiments. One or more of the pages includes code that is executed (or interpreted) by the browser (herein “page code”). Page code includes, among other things, code that communicates with a web server 204 (e.g., JavaScript), and code that communicates with the native code.

As will be described in more detail, code running in the page (e.g., an ActiveX control, Adobe Flash component, or any other bridge or integration point to native code) communicates with a “native device diagnostics code” object group 208, 210, 212 which in turn initializes and communicates with the native device communication code 214. Essentially, the “native device diagnostics code” object group 208, 210, 212 functions as a portal between web browser 202 and the native device communication code 214 (and thus the electronic device). Accordingly, the device “native device diagnostics code” object group 208, 210, 212 enables the web browser 202 to execute native device communication code 214 for the purpose of communicating with the electronic device, among other things.

The native device communication code 214 retrieves information from the electronic device (e.g., the device serial number, among other things). The native device communication code 214 then sends the information back to the browser 202 via the “native device diagnostics code” object group 208, 210, 212, which returns the information to other page code (e.g., JavaScript) for further use (e.g., sending the information to a server, for example).

The native server communication code 206 may include, for example, code (e.g., a .NET dll setup) that is callable from the web browser 202, and which serves as a link between the browser 202 and a “native device diagnostics code” object group 208, 210, 212. Specifically, the web engine 208 adds various functionalities of SRTools, and exposes high-level functions (e.g., “Read All Device Data”) to the native server communication code 206.

Test engine 210 is a normal framework engine, in an embodiment, which provides all of the device commands to the web engine 208. A device communication (comm.) component 212 converts high level tests (e.g., display backlight), and evokes device specific instructions.

Referring again to FIG. 1, although web server 104 and enterprise server 106 are shown as distinct entities, web server 104 and enterprise server 106 may be implemented together (e.g., as a single server), or the functionality of web server 104 and/or enterprise server 106 may be distributed among a plurality of interconnected servers. Web server 104 is configured to deliver content (e.g., web pages) associated with the SRTools application to client workstation 102, in response to requests from a browser instantiated on client server 102. In addition, web server 104 may provide a unit (device) profile data (UPD) web service and a device authenticity web service, and may provide access to a Customer Relationship Management (CRM) system 150 (e.g., the Siebel system by Oracle Corporation) and/or a repair management system 152 (e.g., the iCare system by Oracle Corporation), among other things. The CRM system 150 may access a CRM database 148, in which consumer cases and various repair information may be stored. The repair management system 152 may create a repair request, which may be stored in a repair management database 154, when a consumer indicates that they would like to submit their device for service, as described later.

Enterprise server 106 functions as a database server, thus providing access, via web server 104 or directly to client workstation 102, to enterprise and other data associated with the SRTools application (e.g., information in a remote software download database 140, and a knowledge management database 146, among other things). Enterprise server 106 may implement a knowledge management system, in an embodiment, which maintains and provides access to a repository of documents or files that include information for presentation to the user at the client workstation. Enterprise server 106 may be affiliated with a particular business entity or organization that may utilize the system for various service and repair related functions. In addition, certain functionality of the system may be accessed by entering a Uniform Resource Locator (URL) associated with the business entity and/or the diagnostic system.

According to an embodiment, several databases (e.g., Structured Query Language (SQL) databases) are accessible to the web server 104 and enterprise server 106. For example, a UPD database 144 may be accessible to web server 104 (or some other server) in conjunction with providing a UPD web service that may perform user and device authentication, and warranty status information, among other things.

In addition, a remote software download (RSD) database 140 that includes versions of software for various electronic devices may be accessible to enterprise server 106 (or some other server). As will be described in more detail later, the RSD database 140 may be accessed during the processes of determining whether a new software version for an electronic device is available, and during the process of performing software updates. In addition, the RSD database 140 may be used to store matrix files that may be downloaded to a device, and log files that are uploaded from the client workstation. The enterprise server 106 (or some other server) also may have access to a knowledge management database 142 (e.g., an RNT (RightNow Technologies) database), which may store trouble shooting information (e.g., frequently asked questions (FAQs)) that may be made accessible to the user.

An SRTools database 144 also may be accessible to web server 104 (or some other server), and may include a number of tables that are used during various processes performed by the SRTools application. For example, an SRTools database 144 may include a device software table (e.g., a Flexible Architecture Standard System Technology (FASST) device software table), which may be used to identify a device model/type based on a Flex ID read from the device. The SRTools database 144 also may include a software carrier/operator table (e.g., a FASST software carrier/operator table), which may be used to determine the carrier(s)/operator(s) that use various device software. The key to the software carrier/operator table may be a configuration ID returned from the device software table, in an embodiment. In addition, the SRTools database 144 may include a master product table that may be used to validate a customer model number (e.g., returned based on analysis of the UPD database 144 or analysis of the FASST device software table). The master product table may contain product configuration information, and the key to the table may be the model number. The SRTools database 144 also may include a product catalog table, which indicates which products ship to a carrier, country, region, and/or sub-region. The key to the table may be the country, region, or service center code returned from a service center profile. The SRTools database 144 also may include a product image table, which links products to product images based on the device model (or an APC code).

FIG. 3 is a simplified, conceptual diagram of various software components and communications interfaces and protocols implemented within diagnostic system 300, in accordance with an example embodiment. More particularly, the diagnostic system 300 of FIG. 3 defines information technology (IT) systems and interfaces that may be used to read information from an electronic device 110, identify the electronic device 110, authenticate a user, determine device warranty information, access enterprise data associated with diagnostics, service, and repair via a knowledge management system, support triage testing (e.g., electronic device functional testing), provide for software updates to an SRTools application and software stored on an electronic device 110, perform other diagnostics, service, and repair related processes, create a repair order in a repair management system, and create a consumer case in a CRM system.

As discussed previously, an embodiment of a diagnostic system 100 includes a web and application server 104, an enterprise server 106, and a client workstation 102, to which an electronic device 110 may be communicatively coupled via a USB connector (e.g., USB connector 130, FIG. 1) or other communications interface (e.g., other wired or wireless interfaces). In a further embodiment, a plurality of electronic devices 110 may be communicatively coupled to a client workstation 102 via a USB hub 302. Communications between the electronic device(s) 110 and the client workstation 102 are conducted over the USB connector in conformance with a USB communications (COM) protocol 304, in an embodiment, although communications between the electronic device(s) 110 and the client workstation 102 may be conducted in other manners, as well.

Software components implemented on client workstation 102 in support of various diagnostics procedures discussed herein include a browser 310 and native code 312, which may include an installed, client-side SRTools application, various dlls, drivers, .ocx files, ActiveX controls, and/or other types of native code, as discussed previously. According to an embodiment, the SRTools application is configured to facilitate communications between browser 310 and the electronic device(s) 110 (e.g., read, write, update, and test).

Browser 310 may be, for example, a version of the Microsoft's Internet Explorer web browser, Apple's Safari web browser, Mozilla Foundation's Firefox web browser, Google's Chrome web browser, or another commercially available or proprietary web browser. In a particular embodiment, browser-based connectivity to the electronic device(s) 110 via the USB connection is achieved using a hybrid of Microsoft ActiveX controls and standards-based JavaScript.

According to an embodiment, browser 310 provides a GUI rendering engine, and the GUI language is determined based on user location. The GUI language may be changed during a diagnostics session, in an embodiment, without re-loading the application or disrupting the diagnostics session workflow. Depending on region specific rules, the GUI rendering component will allow for business-rule enforcement and process policing at the GUI level, and can differ based on legal requirements or enterprise-created requirements. In an embodiment, a “rich” GUI is implemented with AJAX/DHTML, which eliminates “page based” navigation and content display metaphors. Accordingly, the GUI rendering engine provides a web-based application which may appear to the user as a desktop application. Areas within the GUI for the SRTools application 312 where users may find themselves in need of guidance or assistance will be identified, and contextual help is put into place. The contextual help may be delivered in the local language, and may work in tandem with the local-language code.

Software components implemented on web server 104 in support of various diagnostics procedures discussed herein include a shared web server farm (e.g., Microsoft Windows, .NET, and Microsoft Structured Query Language (SQL)) 320, an application server 322, a web server 324, and web services 326, 328 at both the interface with client workstation 102 and enterprise server 106. Communications between the client workstation 102 and the web server 324/web services 326 are conducted over a network (e.g., network 120, FIG. 1) using HTML and/or XML in conformance with HTTP and/or HTTPS (e.g., SOAP), in an embodiment. A complementary, server-side SRTools web application executed on web server 104 implements the diagnostics work flow, which incorporates the diagnostic business logic (e.g., sequence, process, instructions, and resolution). The server-side SRTools web application dynamically generates device specific diagnostic processes using device information (e.g., settings and configurations), consumer-provided issues (e.g., complains and symptoms), device testing capability, and troubleshooting guides.

Software components implemented on enterprise server 106 in support of various diagnostics procedures discussed herein include enterprise services 330 (some giving access to enterprise data) and web services 332 at the interface with web server 104. The enterprise services 330 may provide access to various back-end systems, including a CRM system and a repair management system, in an embodiment. Communications between the web server 104 and the web services 332 are conducted over a network (e.g., network 120, FIG. 1) using HTML and/or XML in conformance with HTTP and/or HTTPS (e.g., SOAP), in an embodiment. In addition, login authentication may be provided using an access protocol, such as a Lightweight Directory Access Protocol (LDAP), in an embodiment.

Embodiments of diagnostic system 100 provide an ability to capture user information and user device complaints, as will be described in more detail later. System 100 provides integration with a variety of enterprise systems (web services) to perform such functions as checking device authenticity, determining warranty and software status, and tie in to an enterprise CRM system, thus facilitating the storage and manage user information and user complaints.

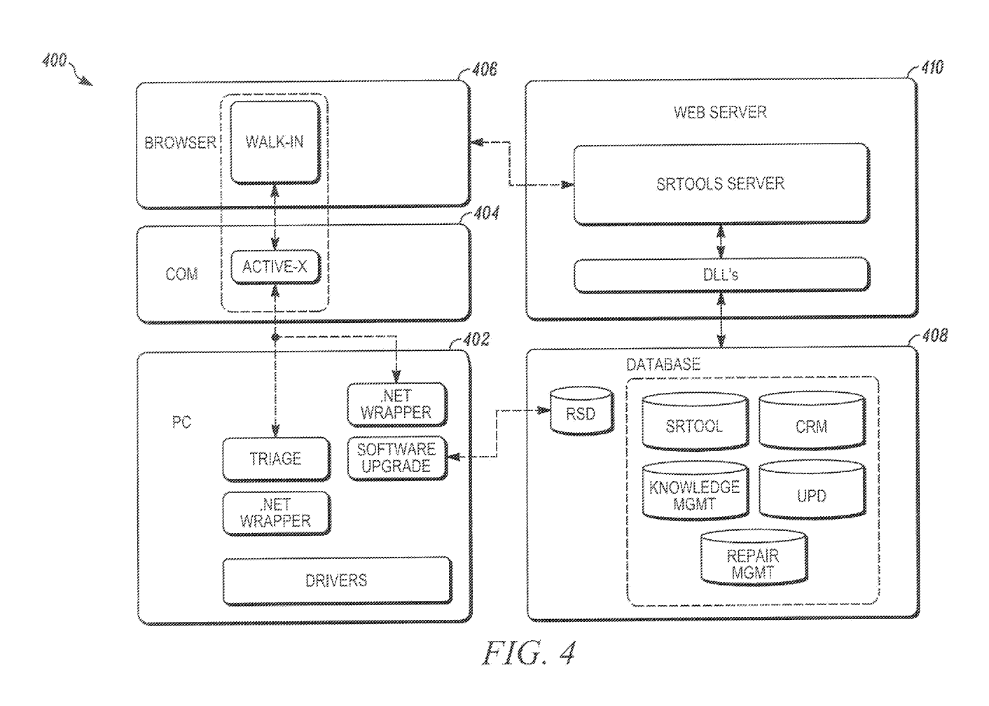

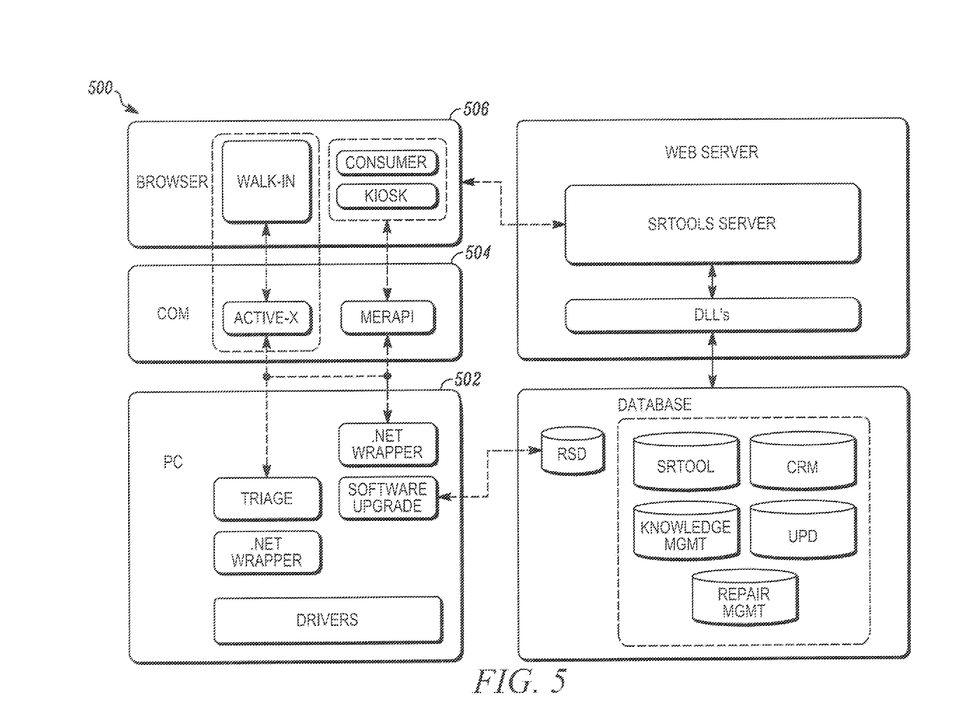

FIG. 4 is a simplified, conceptual diagram of a diagnostic system architecture 400, in accordance with another example embodiment. In the illustrated embodiment, for example, a client workstation (e.g., client workstation 102, FIG. 1) may be implemented in the context of a walk-in service location (e.g., a retail store that supplies and/or services cellular telephones). The client workstation may, for example, be a personal computer (PC), on which native code 402 (including a client-side SRTools application), a device communications (COM) object 404 (i.e., a bridge to native code 402), and a browser 406 are implemented. The walk-in type of GUI presented by the browser 406 may interact, via device communication object 404 (e.g., an ActiveX control or other bridge to native code) with triage, software update, warranty evaluation, and other functional components of the SRTools application. The triage, software update, warranty evaluation, and other functional components may be performed in conjunction with a web server 410 (or “SRTools server”) and various databases 408. Triage components enable various device tests to be performed automatically or in response to user inputs via the GUI. Software updates may be performed using RSD methods, which may provide for access to downloadable software stored in an RSD database that is stored on or accessible to an enterprise server (not shown) (e.g., enterprise server 106, FIG. 1). In addition, the browser 406 may provide for interaction with the web server 410 in order to provide various diagnostic-related services.

FIG. 5 is a simplified, conceptual diagram of a diagnostic system architecture 500, in accordance with another example embodiment. In the illustrated embodiment, for example, a client workstation 502 (e.g., client workstation 102, FIG. 1) may be associated with a walk-in service location and/or a kiosk on which a browser 506 is implemented, which may provide for direct interaction of the user with the system. In contrast with the system of FIG. 4, a device COM object 504 may be implemented using one or more of various interface technologies (e.g., ActiveX controls, a Merapi bridge framework by Roundarch, or other types of bridges to native code), which may provide for interaction between the browser 306 and the SRTools application on the client workstation 502.

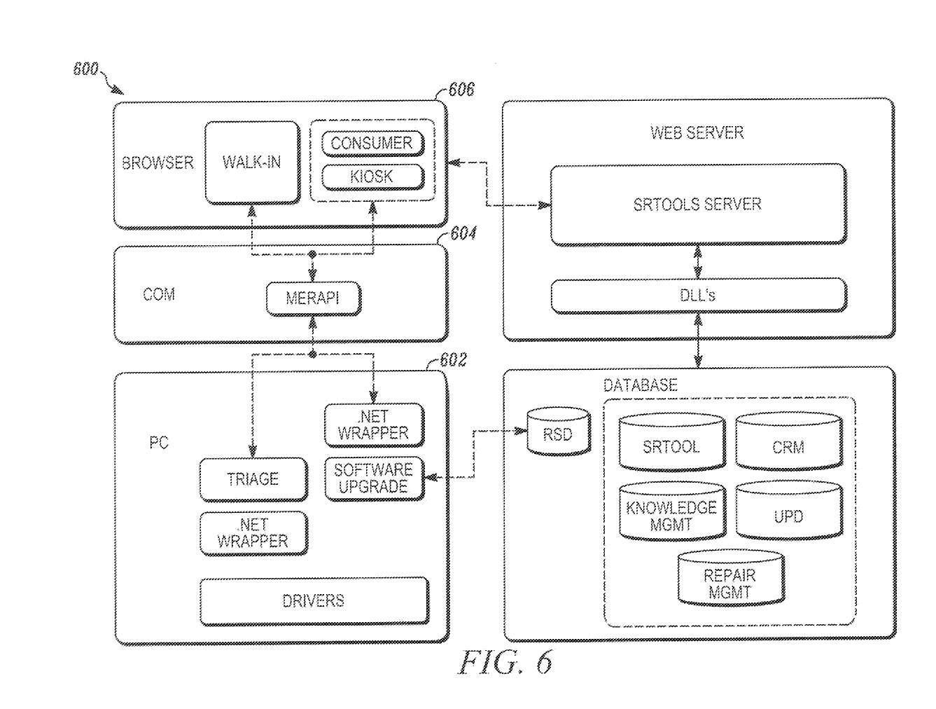

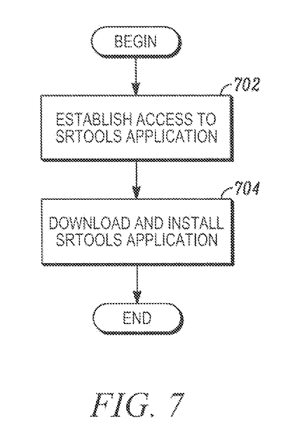

FIG. 6 is a simplified, conceptual diagram of a diagnostic system architecture 600, in accordance with another example embodiment. As with the example embodiment of FIG. 5, a client workstation 602 (e.g., client workstation 102, FIG. 1) may be associated with a walk-in service location and/or a kiosk on which a browser 606 is implemented, which may provide for direct interaction of the user with the system. In contrast with the systems of FIGS. 4 and 5, a device COM object 604 may include a singular type of interface technology (e.g., a Merapi bridge framework by Roundarch) to access triage and software update functionalities for both the walk-in service location and the kiosk location.

Prior to using an embodiment of a diagnostic system (e.g., system 100, FIG. 1) to perform actual diagnostics and/or service for a particular electronic device (e.g., electronic device 110, FIG. 1), various functionalities of the system are first established. This process may be referred to herein as an SRTools installation. FIG. 7 is a flowchart of a method for installing diagnostic functionality within a diagnostic system, in accordance with an example embodiment. More particularly, the diagnostic functionality (e.g., native code) is installed on a client workstation (e.g., client workstation 102, FIG. 1) prior to performing actual diagnostics of an electronic device (e.g., electronic device 110, FIG. 1). Installation of the diagnostic functionality assumes that a web browser already is installed on the client workstation. In addition, other software tools to facilitate and/or augment the diagnostic functionality also may be installed. For example, the other software tools may include tools to add animation, video, and interactivity to web pages (e.g., Adobe Flash). In addition, tools to provide mobile data synchronization technologies and protocols (e.g., Microsoft ActiveSync) may be installed.

According to an embodiment, the method may begin, in block 702, by establishing access by a client workstation (e.g., client workstation 102, FIG. 1) to a server upon which an appropriate versions of native code associated with the SRTools application is stored (e.g., enterprise server 106, FIG. 1 or another server that supports diagnostics and/or RSD) in order to initiate installation of the native code. For example, the installation process can be initiated automatically through a website or the installation files can be provided to be installed through an offline installation process. Software and driver updates may occur periodically or occasionally (e.g., to align with new electronic device launches).

The SRTools installation includes installing the native code, including the client-side SRTools application and a plurality of components (e.g., various drivers configured to facilitate communications between the client workstation operating system and the device via the data connection (e.g., the USB connection), a triage component (e.g., a functional test engine that implements a plurality of functional tests of the electronic device), a software update component (or software update application), a software framework (e.g., the Microsoft .NET Framework), and/or ActiveX controls, among other things).

Administrator rights may be required to complete the installation. Users of the SRTools application, however, may not be required to have administrator rights, although they should be set up to access and run the SRTools communication components. According to an embodiment, the user may be prompted to accept terms and conditions of the software installation (e.g., an end user license agreement). In addition, an environment checker executed on the client workstation may verify various client workstation attributes. For example, these attributes may include characteristics (e.g., versions, sizes, and so on) of the operating system, memory, virtual memory, the web browser, the software update tool version, the triage tool version, and the driver versions, among other things.

In block 704, the native code (e.g., SRTools application, drivers, triage component, software update component, and so on) may be downloaded from the enterprise server (e.g., server 106, FIG. 1) or elsewhere, and installed onto the client workstation. As indicated above, installation may include downloading all components associated with establishing a connection between the client workstation (e.g., client workstation 102, FIG. 1) and an electronic device (e.g., device 110, FIG. 1), performing software updates for the electronic device, and performing triage functions (e.g., electronic device functional testing). In addition, the software framework and other software components also may be downloaded, when applicable. According to an embodiment, indications of the current status of the download and installation processes may be displayed on the client workstation as the download and installation proceeds.

In some instances, versions of the native code associated with the SRTools application previously may have been downloaded and installed on the client workstation. In such instances, the SRTools application, when initiated, may check and verify whether all necessary native code is installed on the client workstation, whether new device tools or drivers are available, and/or whether the native code associated with the SRTools application have become outdated (e.g., if newer versions are available). When all necessary software and components are not installed, new device tools or drivers are available, and/or if newer versions are available, the SRTools application may notify the user, and may provide the user with the option for initiating download of additional or updated components. When accepted, the download and installation process may proceed. Upon verification that the appropriate versions of the SRTools application, and the various drivers, software, and components have been successfully downloaded and installed on the client computer, the method may end.

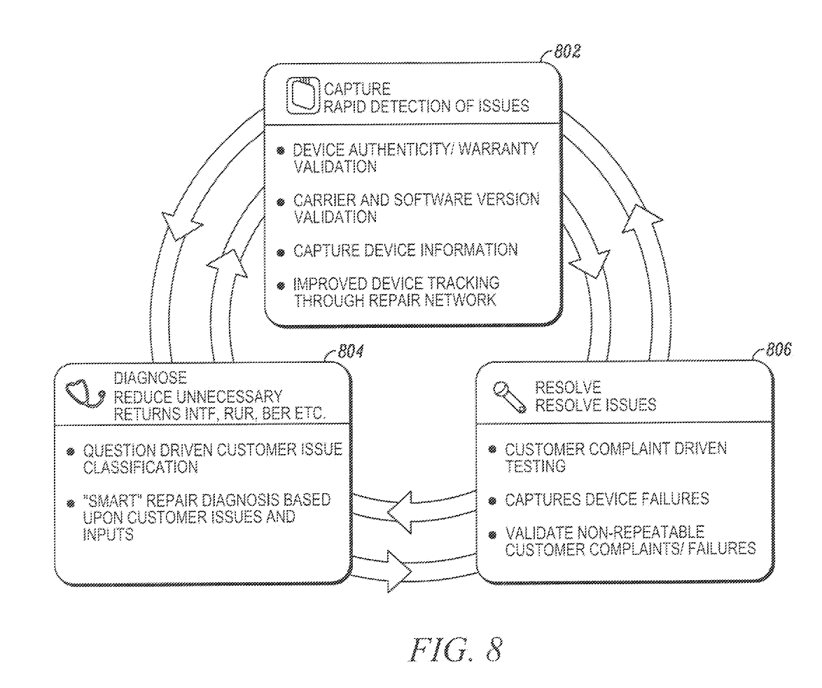

Once the various functionalities are established within the system, an electronic device (e.g., electronic device 110, FIG. 1) may be connected with the system, and the system may be accessed in order to perform actual diagnostics and servicing of the electronic device in the context of an end-to-end receive, diagnose, and repair process. FIG. 8 is a simplified, conceptual diagram illustrating several of the major functionalities that may be provided by an SRTools application of a diagnostic system, in accordance with an example embodiment. More particularly, these functionalities include, but are not limited to, “capture,” “diagnose,” and “resolve” functionalities.

The capture functionality 802 may be accessed to provide for rapid detection of operational issues being exhibited by the electronic device. Sub-functions that may fall under the purview of the capture functionality may include, but are not limited to, performing device authenticity/warranty validation, performing carrier and device software version validation, capturing information relating to the device, and providing for device tracking through the repair network.

The diagnose functionality 804 may be accessed to diagnose operational issues, which may result in a reduction in the quantity of unnecessary returns of electronic devices to repair facilities. Sub-functions that may fall under the purview of the diagnose functionality include, but are not limited to, prompting users for information regarding perceived operational issues (e.g., question driven customer issue classification), and making “smart’ repair diagnoses based upon the customer inputs.

Finally, the resolve functionality 806 may be accessed to reduce device testing time. Sub-functions that may fall under the purview of the resolve functionality may include, but are not limited to, perform triage testing (e.g., of device functionality) based on the customer complaints (e.g., customer complaint driven device testing), capturing device failures, and validating non-repeatable customer complaints and failures.

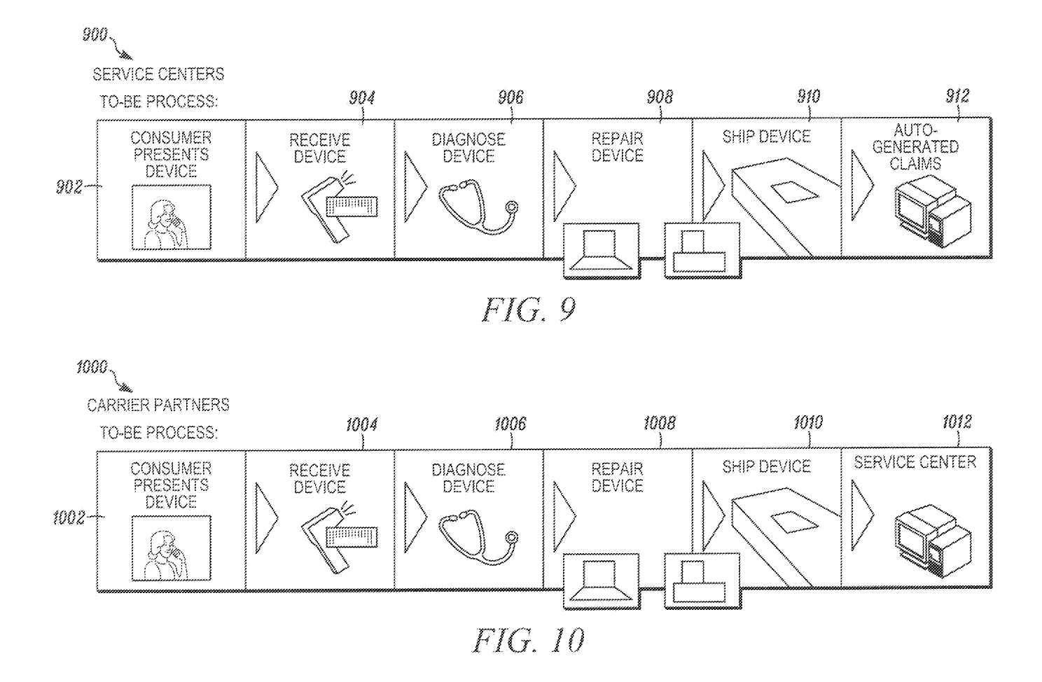

FIGS. 9 and 10 are more detailed, conceptual diagrams illustrating sequences of events that may be performed in conjunction with the end-to-end process of electronic device diagnosis and repair, in accordance with various embodiments. The event sequences in FIGS. 9 and 10 will be discussed only briefly in conjunction with these figures, as they will be discussed in more detail later in conjunction with subsequent figures.

The event sequence 900 depicted in FIG. 9 may be performed in conjunction with a repair process in which the diagnosis and repair processes are performed under the purview of a particular, authorized service center (e.g., a service center associated with an OEM). In event sequence 900, a consumer may present an electronic device to the system 902. This may include the consumer (or personnel associated with the service center) establishing a connection between the electronic device and a client workstation configured to implement an SRTools application (e.g., by connecting the device to the client workstation via a USB connector). In an embodiment, a user may initiate the SRTools application by opening the browser on the client workstation, and accessing the SRTools application (e.g., entering a website associated with the web server that supports the diagnostic functionality). The client workstation may receive the device 904 by providing a means for the user to interact with the SRTools application to enter various information. For example, this may involve the browser accessing (e.g., from a web server) and initiating display of one or more pages, with which the user may interact in order to enter a device model, serial number, and/or other information relating to the device. In conjunction with the user presentation of the device and the client workstation reception of the device, the SRTools application may capture and validate, through interaction with the web and/or enterprise servers, information associated with device authenticity, warranty, carrier/operator, and software version, among other things.

The client workstation may then support diagnosis of the device 906, which may include the browser accessing (e.g., from the web server) and initiating display of one or more pages with which the user may interact in order to enter information regarding the perceived operational issues or problems with the device. Based on this information, the client workstation may determine one or more potential diagnoses, and may graphically present information regarding the diagnoses to the user. In addition, the client workstation may automatically perform triage testing (e.g., device functionality testing) and/or may present the user with options regarding which types of triage tests the user would like the system to perform. The results of the various triage tests may factor into the diagnosis of the device's operational issues.

Upon determining a diagnosis, the client workstation may provide information regarding possible resolutions to the operational issues, and/or may initiate device repair 908. This may include the client workstation displaying information to the user, which indicates that the device's software is out of date, and requesting permission from the user to initiate a software update process. Given permission, the SRTools application may coordinate execution of the software update.

In addition, the client workstation may coordinate other “fixes” and/or may interact with the user to provide step-by-step instructions on how the user may resolve the operational issues (e.g., providing instructions relating to device power cycling, user interface manipulation, and so on). Having implemented one or more software update and/or repair procedures, a quality test may be performed to determine whether the operational issues have been resolved.

When it is not possible or practical to implement device repairs using the SRTools application on the client device, the client workstation may collect additional information from the user (e.g., mailing address), and may instruct the user to ship the device 910 to an authorized repair service center. Using information collected by the client workstation from the user and the device, a repair claim automatically may be generated 912. Trained technical repair personnel at the repair service center may access the repair claim once the device arrives at the service center, and the information contained within the repair claim may facilitate device repair.

Referring now to FIG. 10, a similar event sequence 1000 is depicted. The event sequence 1000 of FIG. 10 may be performed in conjunction with a repair process in which the diagnosis and repair processes are performed under the purview of a carrier partner or other entity (including the user himself or herself), which is not an OEM. For example, event sequence 1000 may correspond to a situation in which a user (or consumer) initiates a diagnostic procedure at a walk-in-service location. In such a case, the user may present the device 1002 by handing the electronic device to service location personnel, who may initiate performance of the diagnostic procedure on a client workstation located in the walk-in-service location. Events 1004, 1006, 1008, and 1010 each are similar to corresponding events in FIG. 9, and accordingly those events will not be discussed in detail.

The diagnosis and repair processes implemented by different carrier partners (or other entities) may differ significantly. FIG. 10 highlights the concept that the SRTools application functionality is flexible and configurable enough to meet the business needs of various types of repair touchpoints. For example, carrier “A” might only perform capture at an initial touchpoint, and all other repair testing may be performed at down stream touch points. In contrast, carrier “B” may implement capture, software update, and device triage at a first touch point. Embodiments of the SRTools application are flexible enough to allow different carrier partners or other entities to implement diagnosis and repair processes in a variety of different manners.

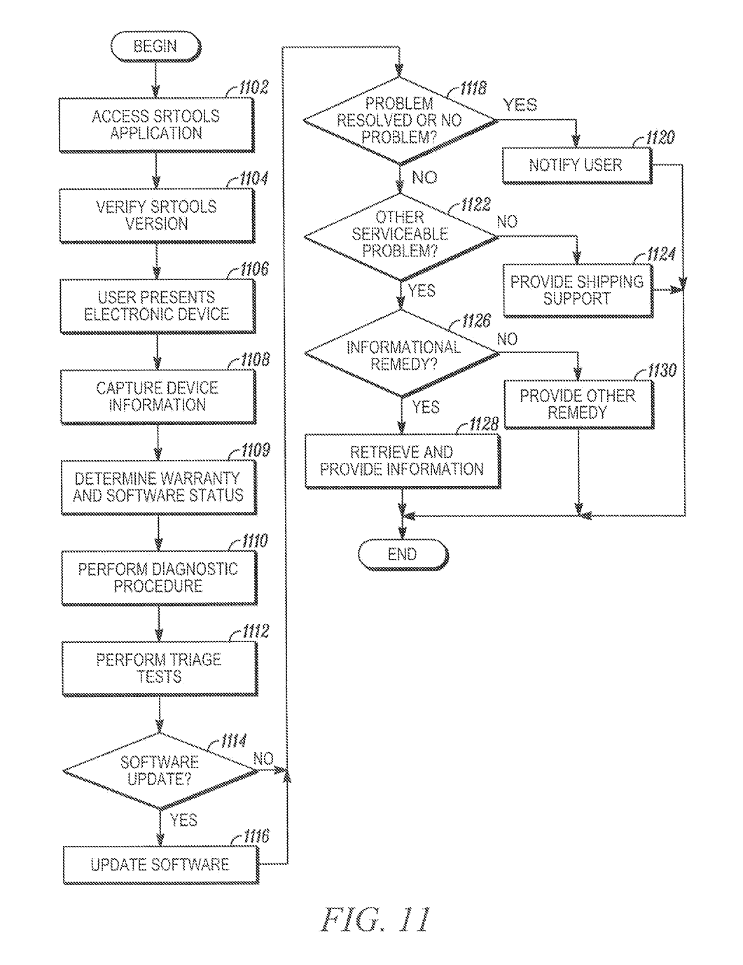

FIG. 11 is a flowchart of a method for using a diagnostic system (e.g., system 100, FIG. 1) to implement device capture, diagnosis, and repair processes, in accordance with an example embodiment. The steps of FIG. 11 may be performed, for example, after a diagnostic functionality has been installed on a client workstation (e.g., as described in conjunction with FIG. 7). Although FIG. 11 depicts a particular set of processes arranged in a particular order, it should be understood that the various processes may be performed in different orders, certain of the processes may be collapsed into a single process or expanded to multiple processes, and/or additional processes may be performed. In addition, because an embodiment implements a GUI that is presented to the user, certain of the processes may be accessed directly through user interaction with selectable options presented via the GUI.

In a particular embodiment, the method may begin, in block 1102, when a user accesses the SRTools application using the client workstation (e.g., client workstation 102, FIG. 1), thus initiating a diagnostic session. According to an embodiment, the SRTools application is accessed via a browser executing on the client workstation. The SRTools application may store session information (e.g., locally on the client workstation), which may enable the user to leave the SRTools application and to return at a later point.

In an embodiment, the browser is configured to display at least one page that includes code configured to communicate with a server (e.g., servers 104, 106, FIG. 1), and a page device communication object (e.g., an ActiveX control or other bridge to native code on the client workstation) configured to interact with native code for the purpose of communicating with the electronic device (e.g., electronic device 110, FIG. 1). Accordingly, to initiate the diagnostic session, the browser may load a previously-installed software component dll (e.g., an ActiveX dll) into memory, and initialize the SRTools framework. Each time the SRTools application is executed, the SRTools application creates a local file (on the client workstation) that contains proxy information that is used to access an external network (e.g., the Internet or network 120, FIG. 1).

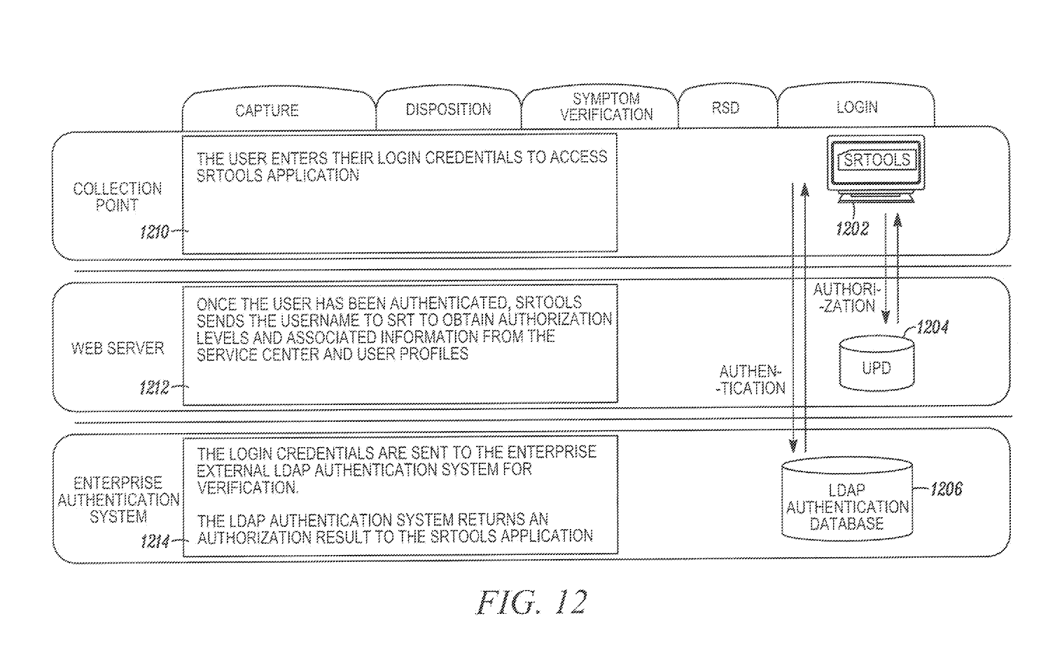

An optional login procedure may be performed, in conjunction with accessing the SRTools application. The login procedure may be performed, for example, for service center employees and enterprise employees, for example. In general, the login procedure may not be performed for consumers who are directly accessing the SRTools system (e.g., from their own computer or a kiosk, for example). FIG. 12 is a conceptual diagram illustrating interaction between various system components (i.e., a client workstation or collection point 1202, a web server with access to a UPD database 1204, and an enterprise authentication system with access to an authentication database 1206) in conjunction with a login process, in accordance with an example embodiment. In step 1210 of the login process, the user enters their login credentials (e.g., user ID and password) to access the SRTools application. In step 1212, the login credentials are sent from the collection point 1202 to the enterprise's authentication system for verification against the authentication database 1206. According to an embodiment, the enterprise's authentication system utilizes LDAP to enable login credential verification in conjunction with the authentication database 1206. The authentication system returns an authentication result or LDAP user account profile (e.g., user ID, service center ID, service role, preferred language) to the SRTools application. The SRTools application may determine which fields are displayed and what functionality is presented based on the user's service role returned with the LDAP user account profile, in an embodiment. Service roles may include, for example, a carrier, an employee status, and so on. Once the user has been authenticated, in step 1214, the SRTools application sends the username to the web server to obtain authorization levels and associated information from the service center and user profiles (e.g., from UPD database 1204).

Referring again to FIG. 11, in block 1104, the SRTools application may then validate that the client workstation has installed thereon the most current environment components. For example, this process may include the browser reading and comparing currently available and installed versions of native code (e.g., various drivers, software components, and software framework (e.g., .NET Framework) versions) to determine which components, if any, are outdated. When any of the components are outdated, an update process is initiated to download the latest client installer, which may then be used to update the outdated components. The update process may include informing the user (via the GUI) that various components are in need of updating, and prompting the user for permission to perform the updates.

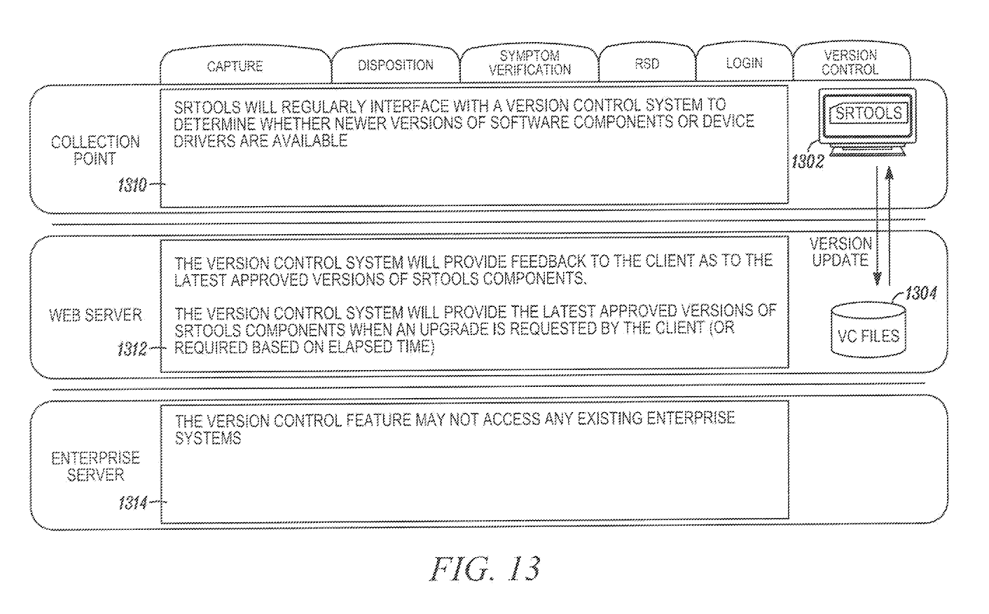

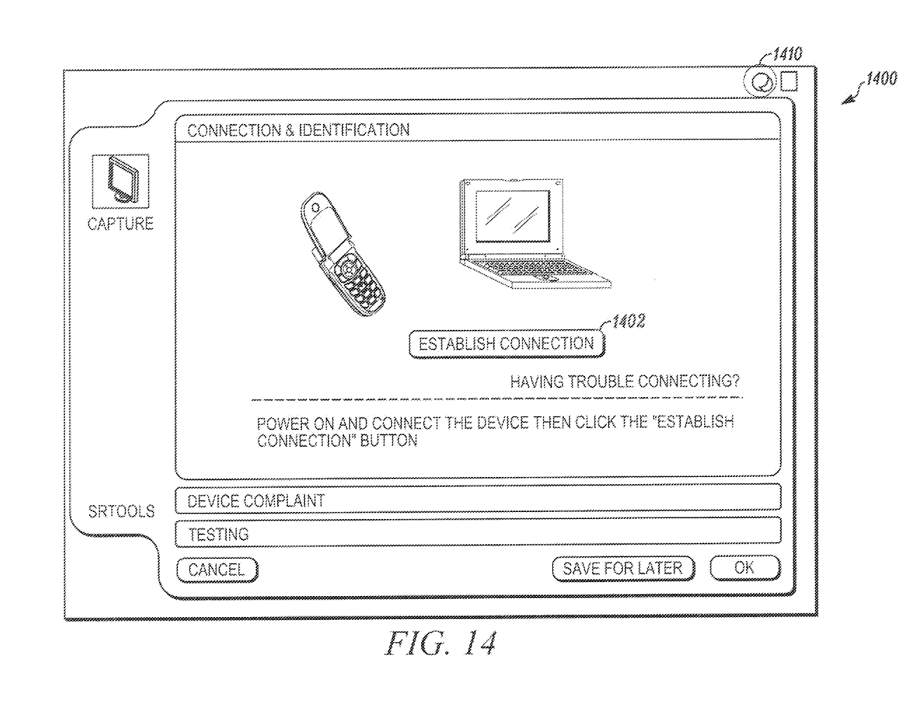

FIG. 13 is a conceptual diagram illustrating interaction between various system components in conjunction with performing version control (VC) for the native code associated with the SRTools application on the client workstation (i.e., a client workstation or collection point 1302), in accordance with an example embodiment. In step 1310 of the version control process, the SRTools application interfaces with a version control system to determine whether newer versions of native code (e.g., software components, device drivers, and so on) are available in the version control files 1304. In step 1312, the version control system provides feedback to the client workstation as to the latest approved versions of the SRTools components. When an upgrade is requested by the client workstation (or required based on elapsed time), the version control system will provide the latest approved versions of the SRTools components. According to an embodiment, the version control feature may not access existing enterprise systems.

Referring again to FIG. 11, the browser may display various web pages with which the user may interact to proceed with the device diagnostic procedure of FIG. 11. More specifically, each of the various pages may include one or more icons, queries, or other page elements that enable the user to make selections and/or enter information into the system. Although particular examples of pages are discussed herein and illustrated in the Figures, it is to be understood that the layout and arrangement of the various pages may be significantly different from the given examples, while still providing the various functionalities discussed herein. For example, although particular graphics, icons, selectable elements, and other page elements are discussed herein as being associated with particular pages, it is to be understood that the graphics, icons, selectable elements, and other page elements may appear on different pages than the given examples. In addition, although the description may describe a user selection or informational input as being made with a particular type of page element, it is to be understood that user selections or informational inputs may be made using other types of page elements. For example, but not by way of limitation, although a user selection may be described as being made via a displayed icon, the same user selection alternatively may be made via a drop-down menu, inputs into a text field, or in another manner.

According to an embodiment, the browser may provide a “device details” widget during the diagnostic process. The device details widget may return, for display in conjunction with one or more pages, a number of device detail items as they become available, such as the device model and the carrier/operator. The device details widget may display “Unknown” for any detail for which data is unavailable. The device details widget also may display an image of the device, if one is available. Other widgets may include, for example, a “warranty” widget (indicating the warranty status and other warranty information), a “software update” widget (indicating the software update status and whether or not a software update is available), a “connection status” widget (indicating the status of the connection between the electronic device and the client workstation), and a “notes” widget (enables a user to refer past notes and enter new notes about the currently connected device). In addition, a “forecast navigation” widget also may be provided to indicate the user's progress through the entire diagnostic process, and/or through a particular part of the process (e.g., indicating the steps of the process and how many steps the user has yet to complete before the process finishes). For example, for a particular process (e.g., establish connection, software update, and so on), the forecast navigation widget may display the steps of the process and any user messages associated with each step.

According to an embodiment, links to online chat may be made available throughout execution of the diagnostic process. Engaging online chat may launch a separate browser window. The SRTools application may pass information about the diagnostic session to the online chat application, in an embodiment.

As an example embodiment, but not by way of limitation, upon entry of an appropriate URL by the user associated with the SRTools application, the browser initially may display a “Main” page or a “Select a Model” page, which provides various selectable elements, one of which may enable the user to indicate the model of the electronic device for which diagnostics is desired.

A “model carousel” including a number of icons representing various device models may be displayed to facilitate user selection of a device model. The model carousel may be displayed during any process in which the user needs to indicate the model of the device (and the carrier/operator, in some cases) to the system. An input field may be provided into which the user may enter a model, and the carousel may be filtered to show matching results. The user may navigate through the models through pagination, as well, in an embodiment. According to an embodiment, user selection of a model (e.g., a windows mobile device or other model) may invoke the SRTools application to display instruction FAQ (frequently asked questions) for that device model, where the FAQs are determined from a knowledge management database (e.g., knowledge management database 142, FIG. 1). User selection of a device model may result in the browser proceeding to a “Service My Product” page, a “Software Update” page, a “Troubleshooter” page, or a “Connection & Identification” page, in various embodiments. Alternatively, the user may access these pages directly without first selecting a device model.

In block 1106, which may be performed before or after either of steps 1102 and 1104, a user (or consumer) presents an electronic device for diagnosis. According to an embodiment, this includes the user establishing a communication connection (e.g., a data connection), either wired or wireless, between the electronic device and the client workstation. According to an embodiment, “presentation” of the electronic device includes physically and communicatively connecting the electronic device to the client workstation via a USB cable (e.g., USB cable 130) between corresponding USB ports on the electronic device and the client workstation. In an embodiment, the user may navigate to a page (e.g., the “Main,” “Select a Model,” “Service My Product,” “Software Update,” “Troubleshooter,” “Connection & Identification,” or other page) associated with the SRTools application that supports establishing the connection, and the user may follow the instructions specified on the page (e.g., “Attach the device to the client workstation via a USB connector”). In an embodiment, after physically connecting the device to the client workstation (e.g., via USB cable 130, FIG. 1), the user may select an icon, such as an “Establish Connection” icon, which initiates the establishment of communications between the electronic device and the client workstation.

FIG. 14 illustrates a first example screen shot that may be presented on a client workstation (via the GUI) in conjunction with the electronic device-to-client workstation connection process. In FIG. 14, a “Connection & Identification” page 1400 provides a graphical depiction of an electronic device (e.g., a cellular telephone, in this case) connected via a USB cable to a client workstation. In addition, page 1400 includes an “Establish Connection” icon 1402 which, when selected by the user, initiates establishment of a data connection between the electronic device and the client workstation. Page 1400 also includes text instructions to the user (i.e., “Power on and connect the device then click the ‘Establish Connection’ button”). When a user fails at an attempt to connect the device, an online chat link may be made available, in an embodiment. According to another embodiment, page 1400 also may include a recover icon 1410. When the electronic device is in Flash mode, a user may select the recover icon 1410 to recover the electronic device.

During the process of establishing the connection between the electronic device and the client workstation, various messages may be displayed by the browser. For example, after a user has specified a device model, one or more “pre-connect” messages may be displayed, which may be model specific. A pre-connect message may be displayed before a physical connection between the device and the client workstation has been made, and display content that depends on the carrier/operator and the device model selection may be displayed in conjunction with the pre-connect message. A pre-connect message may say, for example, “Before we establish a connection to your device, you'll need to make sure that there is enough charge in the battery and that the cable is connected to the client workstation at one and the electronic device on the other. Once you have done this, select the ‘Establish Connection’ icon.” During an attempt to establish a connection between the electronic device and the client workstation, the SRTools application automatically may verify the battery level of the electronic device to determine whether the connection should be made. In an embodiment, establishment of the connection may not be possible when the battery level of the device is below a threshold (e.g., 25% charge, or some other threshold) and the device is not connected to line power.

A pre-connect message also may provide device-specific instructions. For example, a pre-connect message may instruct the user to switch the device into a modem mode (or any other mode required for the client workstation to read device data) prior to connecting the device to the client workstation via a USB cable. For example, for one type of device, the instructions “select Main Menu>Settings>Phone Settings>USB Connection Type>Modem, and restart the device” may be displayed, while for another type of device, the instructions “select Settings>Connections>USB Connections>USB Setting>Modem” may be displayed.

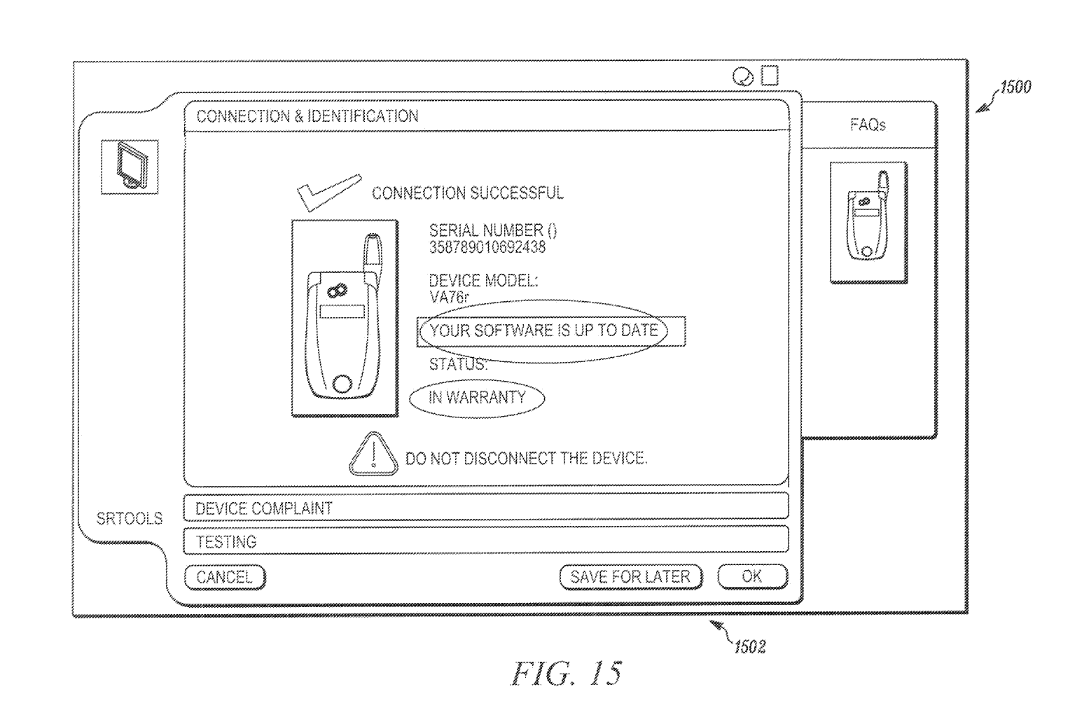

FIG. 15 illustrates a second example screen shot that may be presented on a client workstation in conjunction with the electronic device-to-client workstation connection process. In FIG. 15, the “Connection & Identification” page 1500 includes an indication that the connection between the electronic device and the client workstation was successful. In addition, page 1500 includes a device details widget 1502, as discussed above. Although the device details widget 1502 is shown as being populated in FIG. 15 with information regarding the warranty status and software status, those fields may not be populated until later in the process (e.g., in conjunction with performing step 1109, discussed below).

Referring again to FIG. 11, in block 1108, the system captures information from the electronic device using a device communication component (and possibly the user via the client workstation user interface), and returns some or all of that device information to the server (e.g., web server 104, FIG. 1) for further processing. According to an embodiment, the browser gives the device communication component, which configured to communicate with the device, a callback function that can be used to return results and status. The device communication component may use the callback function to return all results and status until a shutdown call is made.

For example, in an embodiment, unless previously indicated by the user (e.g., in step 1106), the client workstation determines the device model and, when appropriate, the carrier/operator (e.g., the cellular telephone carrier). In addition, the client workstation determines and/or captures (i.e., reads) various device information from the device (e.g., via the USB connection). For example, in conjunction with a page device communication object and the native code, the client workstation may determine and/or read device model information, the activation date, software versions, the device Flex, the baseband ID, the keypad lockcode, the serial number, and other information from the device. In an alternate embodiment, the serial number may be entered by the user manually (e.g., entered as text into a page element), rather than being read from the device. The serial number may be in any of a number of formats (e.g., IMEI, MEID, ESN, CSN, RSN, LSA, or others), and the serial number may be validated based on its format.

According to an embodiment, the device Flex, which is read from the device, is sent to the SRTools server to determine a FASST software configuration programmed into the device. The device Flex may be edited prior to matching to a FASST Flex field, in an embodiment, and the FASST device software table (e.g., of the SRTools database 146, FIG. 1) is searched with the edited result. When the device Flex (e.g., the edited device Flex) matches a FASST Flex field for a particular FASST software configuration, the system determines that that particular FASST software configuration is programmed into the device. In other words, the device Flex is translated, using the FASST device software table, into a FASST software configuration. The following software configuration information may be returned from the server to the client workstation when a FASST software configuration has been identified (e.g., the device Flex matches a FASST software configuration): configuration ID, model number, model name, product, and family, for example. As the above description indicates, the browser sends the device Flex to the SRTools server, and the SRTools server returns the “market” model name and model number for the device, among other things.

Each software configuration installed on the device maps to a specific device model, market model name, and one or more carriers/operators. The configuration ID may be used to retrieve a software customer name, in an embodiment. The browser may then provide the user with an ability to select an appropriate software carrier/operator (e.g., from a drop down list when multiple software carrier/operator names are returned).

The model name, product, and family returned from the server may be used to determine the device model, in an embodiment. Alternatively, when the serial number is found in the UPD database, the customer model number may be returned from the UPD database. The user, alternatively, may manually indicate the device model (e.g., using a model carousel, described later). Either way, in an embodiment, the browser (via the page device communication object) indicates the correct device model (e.g., determined based on the model name, product, and family) to the native device communication code (e.g., via the page device communication object and the native device diagnostics code), in order to enable the native device communication code to read the device detail information from the electronic device. The browser then instructs the native device communication code to read the device detail information (e.g., serial number, activation date, baseband ID, and keypad lockcode) from the device. The device communication object may return progress and results via the callback function. The model number also may be used as a lookup key to retrieving product information (e.g., from the master product table of the SRTools database 144, FIG. 1).

In block 1109, the warranty status and software update status of the device are determined, along with performing other authentication processes. More particularly, according to an embodiment, using the device information read from the device or otherwise received, the client workstation may perform one or more of the following actions by querying a server (e.g., web server 104 and/or enterprise server 106, FIG. 1): checking the warranty status (e.g., using the serial number), checking to see whether a software update is available based on the software version (e.g., by accessing an RSD database), validating device authenticity (e.g., using the baseband ID), validating the serial number, validating the carrier/operator (e.g., the carrier/operator may be obtained from a FASST customer database), and/or establishing tracking information for the device within the system. Success criteria for an established connection between the electronic device and the client workstation may include: successful reading (or entry) of the device's serial number, a determination of the device model, a determination of the device's warranty status, successful reading of the device's software version, and a determination of a software update status. When a device is in recovery mode, it may not be possible to determine the warranty status and software version. Accordingly, for such devices, these success criteria may not apply.

In an embodiment, the baseband ID retrieved from the device is used to validate the authenticity of the device. More particularly, the client workstation sends the device serial number and the baseband ID to the web server to validate the device using the UPD database. The UPD database returns a result (e.g., pass, fail, or N/A), which indicates whether or not the device has been validated.

The serial number captured from the device or manually entered is used to query the UPD database (e.g., UPD database 144, FIG. 1) for device and warranty information. Prior to checking the warranty status, the device's current mode (e.g., normal mode or recovery mode) may be determined. When the device is in normal mode, the warranty status determination process may proceed normally. The warranty status may be determined once the serial number, whether read from the device or manually entered by the user, has been determined. In the event that the user has manually entered the serial number, it is not essential that the device be connected to the client workstation for a warranty status determination to be performed.

As mentioned above, to determine the warranty status, the client workstation uses the serial number to query a server (e.g., enterprise server 106, FIG. 1) for device and warranty information. More particularly, the client workstation may send the serial number to an enterprise server, and using the serial number as a key, the enterprise server may access a UPD database (e.g., UPD database 144, FIG. 1) to determine whether the device associated with that serial number is in warranty or out of warranty. The enterprise server may then provide an indication of the warranty status, along with other information (e.g., device information, shipment information (e.g., ship date, ship to customer name), manufacturing information (e.g., manufacturing date, factory/distribution location), warranty expiration date, original and/or current warranty coverage periods, warranty coverage type, warranty renewal information, repair history (e.g., last repair date, repair count, lifetime airtime timer, activation date), software information (e.g., software version, Flex version, software carrier/operator, software update status), and so on) to the client workstation.

When a determination is made that the device is in recovery mode, the client workstation may determine whether or not it is possible to read the serial number and the software version (or the device Flex) from the device. When it is possible to read the serial number, the warranty check may proceed. When it is not possible to read the serial number, the warranty status check may be skipped. When the warranty status check indicates that the device is out of warranty, an out of warranty error message may be displayed. When the warranty status check indicates that the device is in warranty, and it is possible to read the software version, the recovery process may proceed. Even when the software version cannot be read, the recovery process may proceed, if the device model and carrier/operator can be identified, and the device software file is available in local files.

In an embodiment, and as shown in FIG. 15, after the system performs an analysis of the warranty status, the browser may display (e.g., in the device details widget 1502) some or all of the warranty information returned to the client workstation to the user. For example, the browser may display warranty status (e.g., in warranty or out of warranty), warranty expiration date, coverage type, swap reference number, warranty country, device authenticity, warranty cancel code, POP date, and/or warranty periods (current, original, renewal).

When the device is out of its warranty period, the system may provide a notification to the user, in an embodiment. According to an embodiment, the browser may provide warranty dispute links in the event that the user wishes to challenge an out of warranty status returned by the SRTools application. In addition, when it is established that a device is out of warranty, the user may be presented with options (e.g., links) to purchase an extended warranty, if available. If, at any point, the user indicates that there is physical or liquid damage (e.g., during the complaint capture process), the system may update the warranty status for the device (e.g., in the UPD database) to invalid (e.g., out of warranty), in an embodiment. Even in such an event, the user may still be provided the option of performing a software update.

According to an embodiment, when a device cannot be found in the UPD database, the device may be processed as though it is in warranty (e.g., allowing software updates). In such a case, the warranty status may be displayed as “Unknown” by the browser. In addition to the warranty information, other device information also may be received from the enterprise server and displayed by the browser to the user. For example, device information fields that may be displayed to the user may include device status, serial number, model, Account Product Code (APC, which groups devices into product families), airtime carrier/operator, and so on. In addition, various other items of information may be displayed (e.g., shipment information, manufacturing information, repair history, software information, and so on).

In conjunction with determining the warranty status, a software status check also may be performed. According to an embodiment, the page code interacts with the enterprise server and RSD database in conjunction with the process of determining the software status. More particularly, using the page code sends the software version to a server (e.g., enterprise server 106), which accesses an RSD database (e.g., RSD database 140, FIG. 1) to determine whether the device's software version corresponds to the latest software version for the device. When the server returns a result indicating that the device's software version does correspond to the latest software version, a message indicating that the device software is up to date may be displayed. In addition or alternatively, the browser may provide the user with an option to perform a software update even when the device's software version corresponds to the latest software version. In other words, when the same version of software is available at the server or locally, a “same software” update may be offered.

When a determination has been made that the device is in warranty (or that the device cannot be found in the UPD database), and a newer software version is available in the RSD database (or refurbish software is available), the server may inform the client workstation, and the browser may provide the user with an option to update the device's software. Conversely, when a determination has been made that the device is out of warranty, and a newer software version is available in the RSD database (or refurbish software is available), the user may be informed of the out of warranty status, and the software update may be denied the user.

During the device connection process, one or more “mid-connect” messages may be displayed, which may be model specific. A mid-connect message may indicate a successful physical and data connection between the electronic device and the client workstation, and successful reading of the device information. In addition, a mid-connect message may indicate the status of the device warranty and software status. When a determination is made that a device is in warranty, a software update check may be made. For example, for an in-warranty device, a mid-connect message may say “We have detected that your electronic device is in warranty. We need to check to see if your software is up to date. Switch the mode by following the instruction below and select the ‘Continue’ icon.” As another example, for some types of devices that must be in a particular mode before warranty-related or other data can be read (and the device is not already in that mode), a mid-connect message also may provide instructions for a user to place the device in the required mode that enables the warranty-related or other data to be read.

When the user optionally has performed a mode switching action and/or the connection has been established, one or more “post-connect” messages may be displayed, which may be model specific. At this point, the device information has been read from the device, and the warranty and software status have been returned. A post-connect message may say, for example, “You have successfully connected your device. A new version of the device software is available.” The user may then be provided an option to initiate the software update process, which process will be described in more detail later in conjunction with steps 1114 and 1116. Alternatively, the browser may provide an “Update Device Software” icon on the “Main” page or another page. For some types of devices that must be in a particular mode (e.g., modem mode) prior to initiating a software update, a post-connect message may provide instructions for a user to place the device in the required mode for software update. Alternatively, a post-connect message may include instructions to return the device to a previous mode state, in the event that the user does not desire to proceed with a mode specific activity (e.g., software update).

In block 1110, a diagnostic procedure is performed in order to determine potential operational problems with the electronic device. According to an embodiment, this includes prompting the user to provide information regarding the perceived operational issue (e.g., question driven customer issue or complaint classification). Options to indicate whether or not the device has sustained physical or liquid damage may be provided, in an embodiment, and the user may be required to make a selection to proceed (e.g., since these two types of damage may relate to whether or not the warranty has been invalidated). In addition or alternatively, the user is able to indicate the issue, in an embodiment, by making hierarchical selections of various “complaint” categories and sub-categories, for example, which are listed for the user by the system. Essentially, the complaint capture process will capture the consumer's issue with the device, and then map that issue to one of multiple complaint categories for submission to the CRM system. In addition, the consumer issue may be mapped to one of multiple symptom codes for submission to a repair management system (e.g., repair management system 152, FIG. 1).

According to an embodiment, the user may be prompted to enter complaints through a “Select a Problem Category” control. The user may be able to select a top level complaint category (e.g., in the form of a list or set of icons), and upon selecting the complaint category, a list of sub-categories may be displayed. Upon selection of the sub-category, a list of sub-category issues may be displayed. In other words, the complaint entry process may be hierarchical. For example, but not by way of limitation, complaint categories and sub-categories (in parenthesis) may include the following: alerts (e.g., speaker, vibrator, ringtone); camera (e.g., primary camera, secondary camera, video); accessories (e.g., charger, headset, battery, SIM card, external memory card, address book, calendar, email); parts (e.g., flip, front, rear, battery cover, lens); calls (e.g., cannot make calls, cannot receive calls, drops calls, signal); power (e.g., charger, battery, battery symbol, power off, power on); keypad (e.g., keypad, side keys, touchscreen, navigation device); applications (e.g., games, player, music player, other tools); sound (e.g., speaker, microphone, headset, music, FM radio); Bluetooth (e.g., Bluetooth, WiFi, GPS); connections (e.g., Internet connection; data connection; address book); connectors (e.g., USB cable, headphone/headset, damaged connectors); display (e.g., external display backlight, external display screen, internal display backlight, internal display screen, Internet, MMS, email, text messaging); other (e.g., buyer's remorse, phone overheats, liquid/physical abuse, software, phone hangs/freezes); and so on. Additional sub-category issues may be provided for each sub-category. For example, for the “sound” category and “speaker” sub-category, further sub-category issues may include: no sound; low volume; too loud; fluctuating sound, and so on. In various embodiments, the user is able to enter multiple problem categories, remove a device complaint, and/or edit a device complaint.

In an embodiment, the system may provide a repair diagnosis based upon the user-provided issues and inputs. Once a threshold amount of information regarding the device issue has been entered or determined using the SRTools application, a consumer case may be created in a CRM system (e.g., a Seibel CRM system), regardless of whether or not the device needs to be sent to a service center for repairs. Creation of the consumer case may be initiated by the client workstation sending a message (e.g., a pre-receipt message) to the CRM system. For example, a consumer case may be initiated as soon as the SRTools application has obtained the device's serial number. Other data that may be stored in conjunction with the consumer case may include the airtime carrier/operator, the consumer complaint(s), and other consumer information. The serial number, carrier/operator, complaint(s), and/or other consumer information may be sent in the pre-receipt message, in an embodiment.

The customer case may be stored, for example, in a CRM database (e.g., CRM database 148, FIG. 1), which is accessible to the CRM system. This establishes information regarding the device and the issue with the system, which information is particularly useful if the device ultimately is shipped to a service center for repairs (i.e., the information may be accessed by service center personnel in conjunction with making the repairs). The consumer case should include, at a minimum, consumer information such as a consumer name, a phone number, and an address. Alternatively, an anonymous record using information about the service center may be used to create the consumer case. If the device issue is resolved without the necessity for shipping the device to a service center (e.g., through interaction with the client workstation), the consumer case and any associated service authorization may be cancelled by the CRM system. In an embodiment, a consumer case report may be made available to the user for viewing.

The SRTools application continues to collect information and details about the device and the consumer issue until the user reaches a logical exit point in the application. For example, logical exit points may include the consumer submitting the device for repair, the consumer responding in the affirmative to a “Did this solve your issue?” prompt, the consumer navigating away from the site, or the consumer closing the browser. Once a logical exit point has been reached, the SRTools application creates a consumer case with the CRM system, if it has not done so already (e.g., by sending a pre-receipt message to the CRM system). The SRTools application may then subsequently cancel or close the consumer case, depending on the exit path (e.g., by sending an update message to the CRM system). For example, in cases where the consumer has indicated that the SRTools application has helped them to resolve their issue (e.g., they will not be submitting the device for repair), an update message may be sent to close the consumer case. An update message may be sent to cancel the consumer case in other situations, such as when the consumer opted to submit their device for repair, indicated their issue was not resolved using the SRTools application, or exited the SRTools application without making any indication whether or not their complaint was resolved. When a consumer indicates that they would like to submit their device for repair, a repair request may be created in a repair management system (e.g., repair management system 152, FIG. 1).

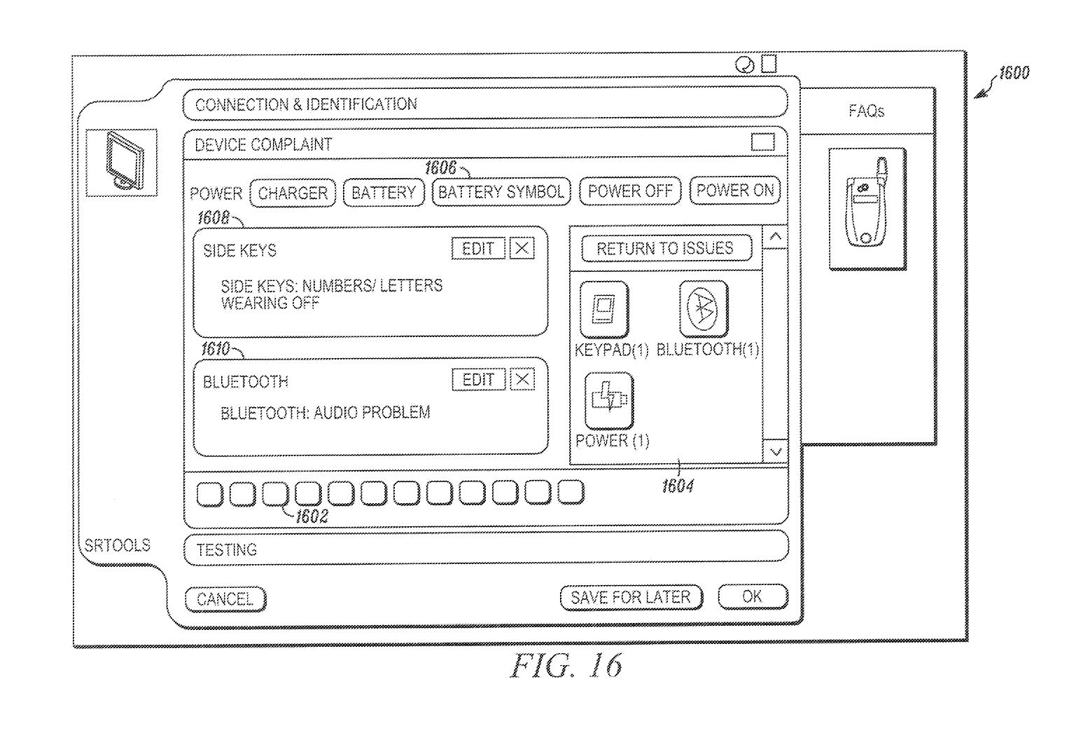

FIG. 16 illustrates an example screen shot 1600 that may be presented on a client workstation in conjunction with the complaint entry process, in accordance with an example embodiment. In the example of FIG. 16, a device complaint page includes a number of selectable category icons 1602 that represent various complaint categories. The page indicates that the user has selected several of the complaint categories (i.e., keypad, power, and Bluetooth) by their inclusion in an issues element 1604 of the page. For example, the user may have sequentially selected the keypad, power, and Bluetooth category icons 1602, and dragged/dropped each icon 1602 into the issues element 1604. To enable the user to specify a sub-category for each selected category, the page also displays a number of selectable sub-category icons 1606. In the particular example, selectable sub-category icons 1606 (e.g., charger, battery, battery symbol, power off, power on) are shown for the power category. Upon selection of one of the sub-category icons 1606, the user would be presented with a list of selectable sub-category issues, which would enable the user to indicate the specific issue that the user is experiencing. Fields 1608 and 1610 indicate that the user has selected sub-categories and sub-category issues for the keypad and Bluetooth categories.

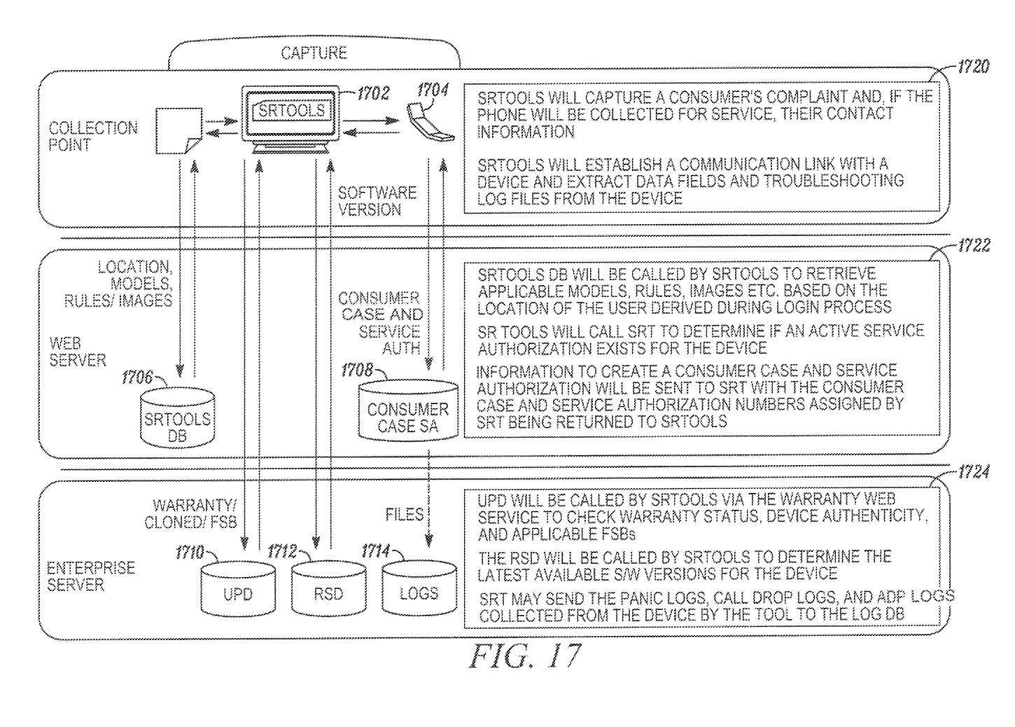

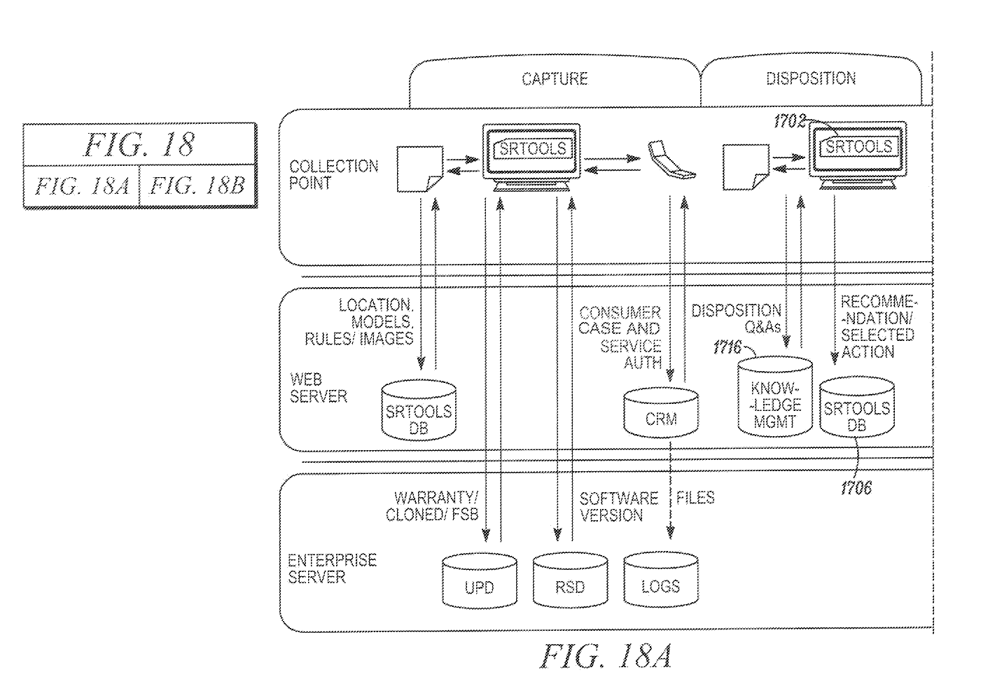

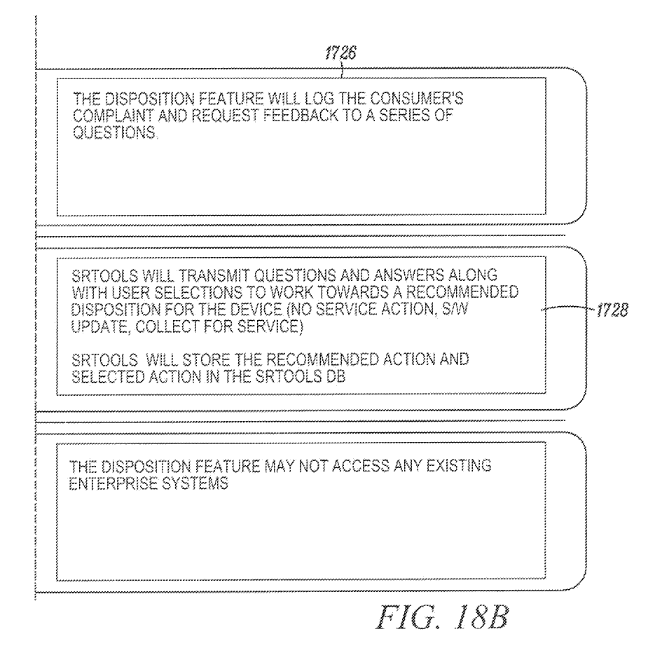

FIGS. 17 and 18 are conceptual diagrams illustrating interaction between various system components (i.e., a client workstation or collection point 1702, a device 1704, and a plurality of databases accessible by a web server, enterprise server, or CRM system (e.g., SRTools database 1706, CRM database 1708, UPD database 1710, RSD database 1712, logs database 1714, and knowledge management database 1716) in conjunction with a complaint entry process, in accordance with another example embodiment. In step 1720 of the complaint entry process, the SRTools application captures the consumer's complaint, and if the device will be collected for service, the consumer's contact information. To facilitate the process, the client workstation 1702 establishes a communication link with the device 1704 to extract data fields and troubleshooting log fields (e.g., panic logs, call drop logs, and ADP logs) from the device 1704.

In step 1722, the client workstation 1702 may interact with the SRTools database 1706 to retrieve applicable device models, rules, device images, and so on, based on the location of the user derived during the login process. In addition, the SRTools application may make a call to determine whether an active service authorization exists for the device 1704. If not, information to create a consumer case and service authorization may be sent to the CRM system, which may return assigned consumer case and service authorization numbers.

In step 1724, the SRTools application may access the UPD database 1710 via a warranty web service to check the warranty status and device authenticity, among other things. In addition, the RSD database 1712 may be accessed to determine the latest available software versions for the device 1704. The SRTools application also may send the various logs collected from the device 1704 to the logs database 1714, in an embodiment.

Referring now to FIG. 18, in step 1726, a disposition feature of the SRTools application may log the consumer's complaint, and may request feedback to a series of questions. In step 1728, the SRTools application may transmit the user's feedback (e.g., questions and answers, user selections, etc.) to a knowledge management system, in order to provide access to information (e.g., FAQs) in the knowledge management database 1716. The information in the knowledge management database 1716 may enable the system to work towards a recommended disposition for the device (e.g., no service action necessary, software update, collect for service, and so on). The SRTools application may store the recommended action and any user-selected action in the SRTools database 1706, in an embodiment.

Referring again to FIG. 11, in block 1112, once the complaints have been entered by the user, various “triage” functional tests may be automatically performed and/or performed at the behest of the user (e.g., through interaction via the GUI). In an alternate embodiment, the system need not perform the preceding method steps in order for the user to be provided access to the triage functionality of the system. Instead, the user may directly access the triage functionality through selection of a triage option (e.g., an icon) displayed by the GUI.

The particular tests performed or offered may be determined based on the model of the electronic device, the carrier/operator, and/or other factors. Some tests may require the user to perform an action, and the application will prompt the user for this interaction. The results of the triage tests may or may not be displayed to the user.

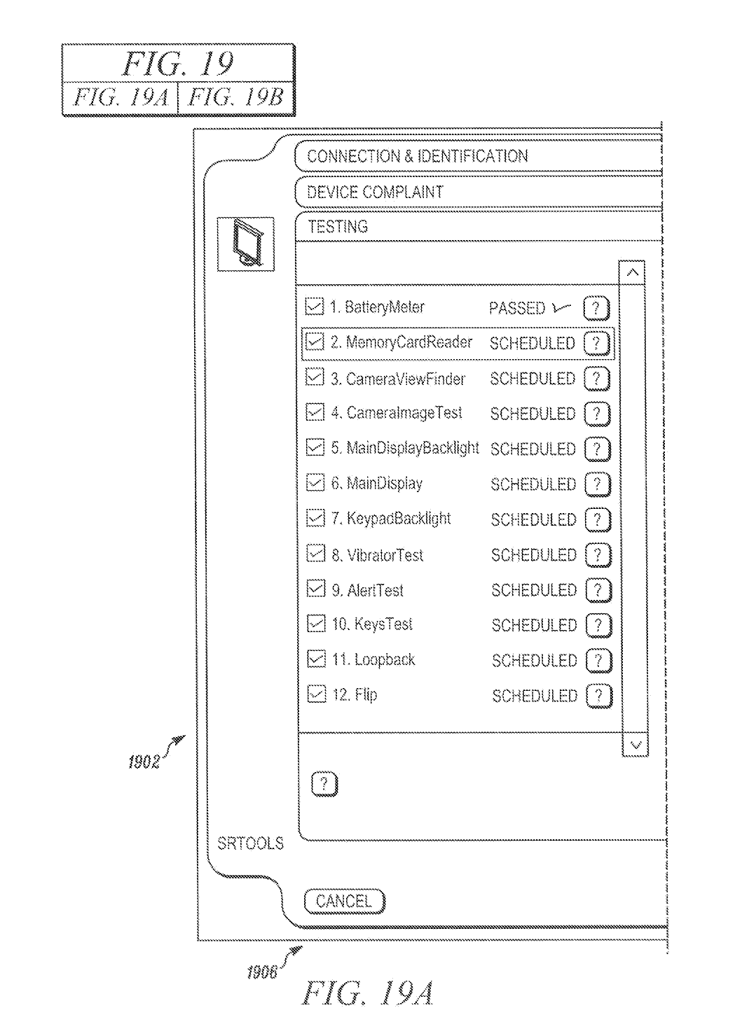

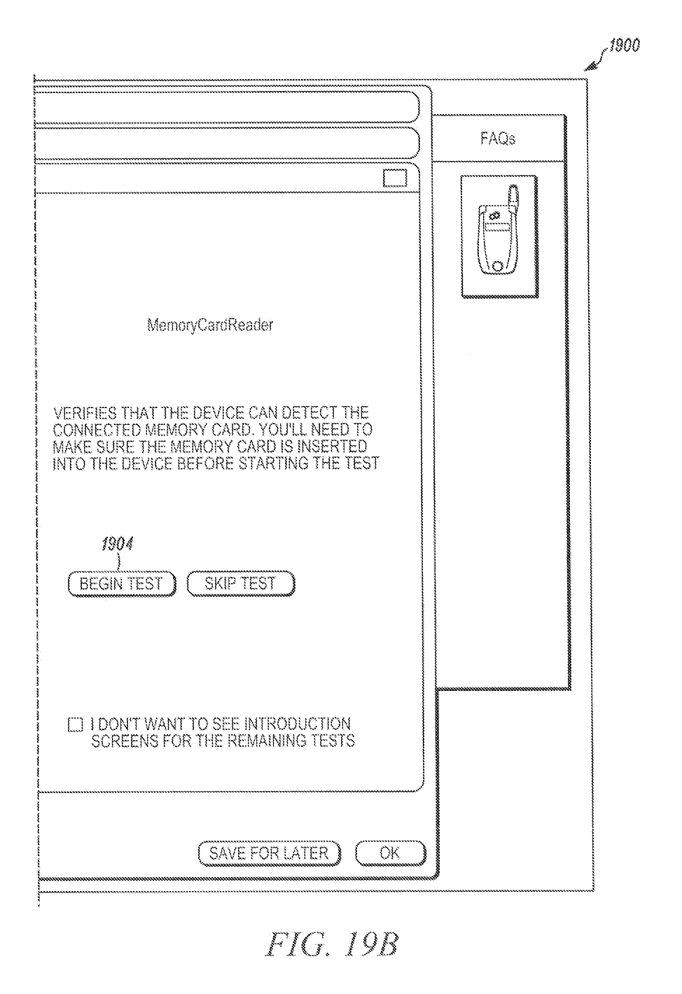

Triage functional tests may include, but are not limited to, battery tests, memory tests, camera tests, and display tests, among others. FIG. 19 illustrates an example screen shot 1900 that may be presented on a client workstation in conjunction with user-selectable device testing procedures, in accordance with an example embodiment. As an example, a testing page may display a list 1902 of user-selectable test options. In an embodiment, the user may select from any one or more of the indicated tests, and click a “Begin Test” icon 1904 to initiate test performance. During the testing process, the status 1906 of the tests may be dynamically updated.

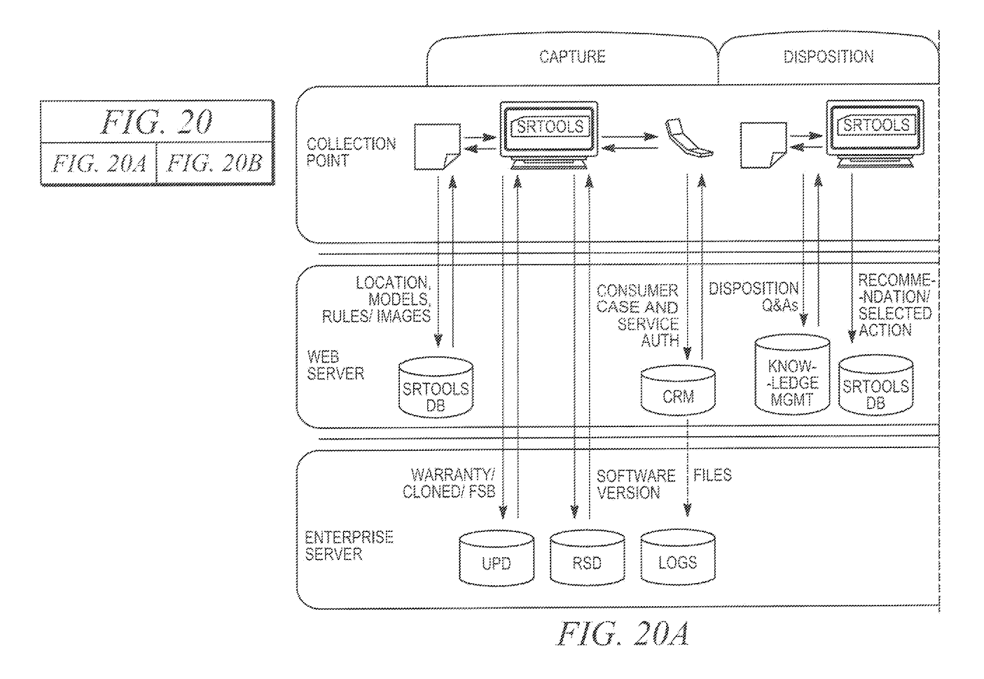

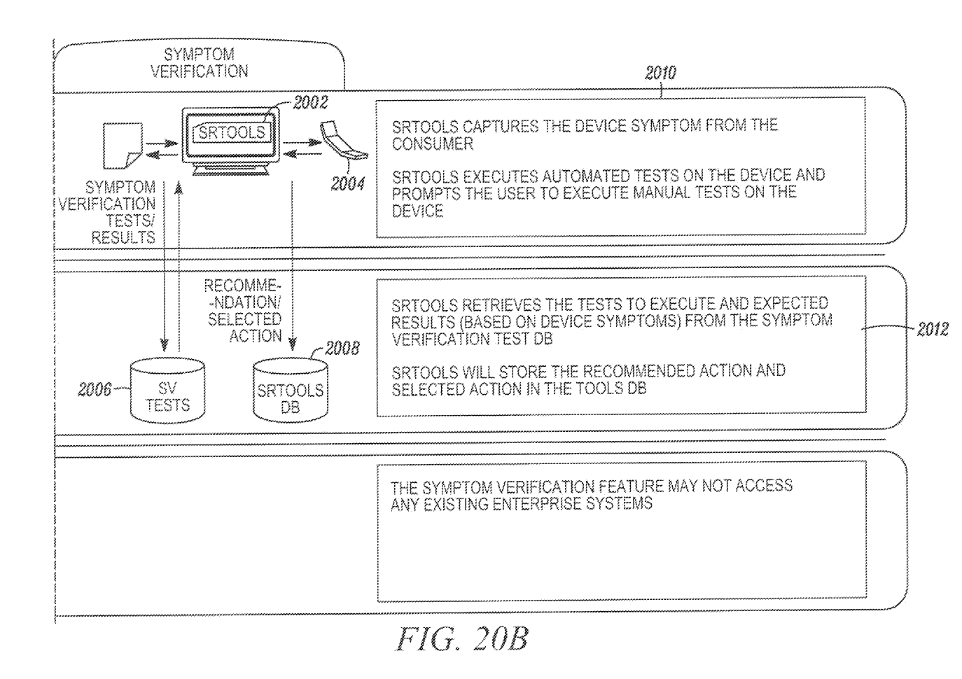

FIG. 20 is a conceptual diagram illustrating interaction between various system components (i.e., a client workstation or collection point 2002, a device 2004, and a plurality of databases accessible by a server (e.g., symptom verification (SV) test database 2006 and SRTools database 2008) in conjunction with a triage process, in accordance with an example embodiment. In step 2010 of the triage process, the SRTools application may capture the device symptoms (e.g., complaints) from the user. According to an embodiment, the SRTools application may initiate execution of automated tests on the device 2004, and prompt the user to execute manual tests on the device 2004.

In step 2012, based on the captured device symptoms, the SRTools application may retrieve the SV tests from the SV test database 2006, along with expected results, and the SRTools application may execute the tests. In addition, the SRTools application may store a recommended action and a user-selected action in the SRTools database 2008, in an embodiment.

Referring again to FIG. 11, in block 1114, a determination is made whether a software update is available and/or whether a software update may resolve the operational problem. For example, this determination may be made affirmatively when the client workstation determines that some software on the electronic device had been corrupted, and/or that new software versions are available for one or more versions of software components installed on the electronic device. Essentially, the software update process may result in updating the device's software with a newer (e.g., the newest) version, or reinstalling a currently installed version of the software.

Although blocks 1114 and 1116 are shown as occurring after blocks 1110 and 1112, the software update process may be performed before blocks 1110 and 1112, as well. As used herein, a “software update” of an electronic device includes updating the electronic device's software files (e.g., replacing, adding, and/or deleting the device's software files). As used herein, the term “software” may be considered to be synonymous with the term “firmware.” Accordingly, a “software update” may be considered to be a “firmware update,” as well.

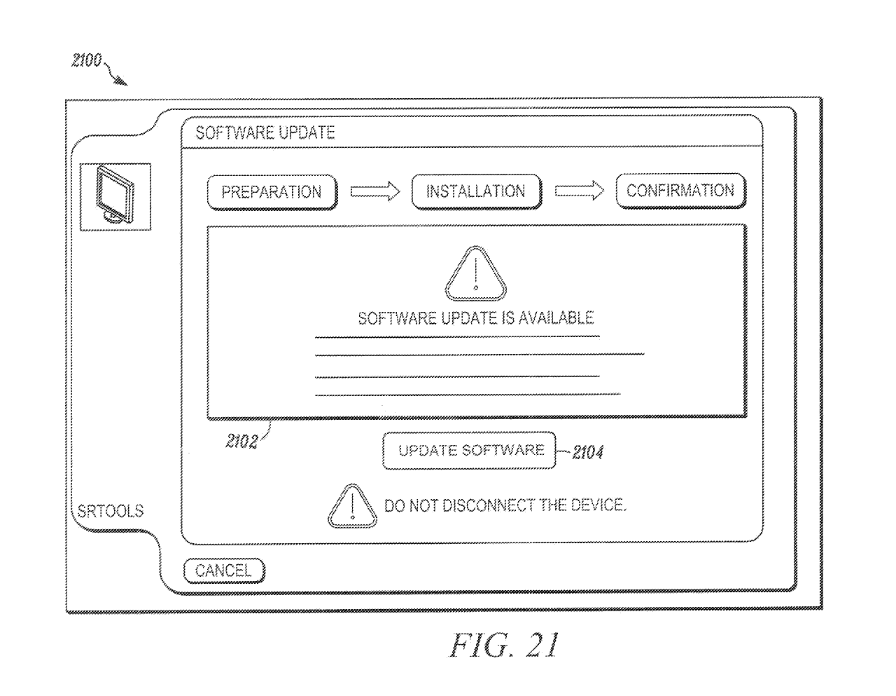

A software update process may be initiated by a user affirmatively indicating that the user desires a software update (e.g., through selection of an option for a software update presented by the browser). For example, FIG. 21 illustrates an example screen shot 2100 that may be presented on a client workstation when a software update is available, in accordance with an example embodiment. As shown, the system may display a message 2102 indicating that a software update is available, and a selectable “Update Software” icon 2104, which enables the user to initiate the software update.

Referring again to FIG. 11, when a software update is available and the user has indicated a desire to perform the software update, then in block 1116, the browser may initiate a download from an RSD database accessible to an enterprise server of the appropriate software to the client workstation. A software update component may provide for server interaction in conjunction with the software update process. The software update component (or other components) also may provide for phone detection, firmware update, backup, restore, and recovery. According to an embodiment, the browser gives the software update component a callback function that can be used to return information and status to the browser. For example, the callback function may be used to provide, to the browser, information such as the percent of upgrade process, resume successfully, upgrade successfully, and so on. User cases that may be handled by callback function may include, for example, the software update component checking for device connection, providing instructions to place the device in the proper mode (e.g., USB mode) for the software update, checking for the device matrix file, checking for a firmware file to download, providing a firmware file download status report, performing a firmware upgrade, providing user instructions for performing a firmware upgrade, providing user instructions to perform a manual restart while flashing, providing user instructions to manually switch to USB mode after flashing, and to upload a log file at the end of an upgrade process, among other things.

In addition, the browser may invoke the page device communications object to instruct the native code to upload of the software from the client workstation to the electronic device. In an alternate embodiment, the system need not perform the preceding method steps in order for the user to be provided access to the software update functionality of the system. Instead, the user may directly access the software update functionality through selection of a software update option (e.g., an icon) displayed by the browser in conjunction with one or more pages. According to an embodiment, an End User License Agreement (EULA) may be displayed to the user whenever a software update is being performed. The user must indicate acceptance of the EULA before the system will proceed with the software update. In an embodiment, the software update process may be denied when the battery level of the device is below a threshold (e.g., 25% charge, or some other threshold) and the device is not connected to line power.

The software update component is configurable, in various embodiments, to look for device software files on the client workstation only, or to download the device software files from an enterprise server. In an embodiment in which the software files are downloaded, the software update component may be configurable to delete the software files after the update has been completed. Alternatively, the software files may be retained on the client workstation, to avoid the necessity of future downloads of those software files. The software update component also may be configurable to backup or not to backup user data (e.g., phonebook, databook, feature settings, messages, and so on) during the software update process, and to restore the information back to the electronic device when the software update process has been completed. The consumer information may be encrypted when stored on the client workstation, and deleted from the client workstation when the software update process has been completed, in an embodiment.

During the process of performing a software update, release notes may be made available, where applicable. Release note availability may be determined from the device's matrix, file, for example, and may be made available via a link. When selected, the release notes may open in a new window.

In addition, various messages may be displayed by the browser while performing a software update. For example, the browser initially may display one or more “pre-update” messages, which may be model specific. A pre-update message may be displayed prior to the user's commitment to perform a software update. A pre-update message may include instructions to the user before initiating the software update process. For example, a pre-update message may say “We have detected that your device is not in the correct mode to perform a software update,” and further instructions for the user to set the device in the correct mode (e.g., modem mode) may be provided. Alternatively, a pre-update message may say “You need to remove your memory card before proceeding,” and further instructions for the user to remove the memory card may be provided. A pre-update message also or alternatively may warn the user that the memory card may need to be re-formatted after updating the device software, and may encourage the user to backup all of the user-personal content on the memory card (e.g., images, videos, music, contacts, calendar, etc.) to another computing device prior to initiating the software update. Instructions regarding performing a backup also may be provided. The user may be provided with an option to skip backup after confirming a possible loss of date. Further, a pre-update message may include a warning message for the SIM/device lock status of the device.

When the user has performed an action indicating the user's commitment to perform the software update (e.g., by selecting an “Update Software” button), one or more “mid-update” messages may be displayed, which may be model specific. A mid-update message may provide instructions or warnings during the software update process that should be completed before continuing with the update process. For example, a mid-update message may include a pre-back up instruction, such as “We cannot back up your device automatically. Please perform a manual back up, and select ‘Continue’ to proceed.” Instructions for performing a manual back up may also be displayed. Alternatively, a mid-update message may include a pre-restore instruction, such as “Before restoring your device, you will need to switch to the correct mode,” and further instructions regarding switching modes may be displayed.

When the software update has been completed, the browser may display one or more “post-update” messages, which may be model specific. A post-update message may indicate that a software update was successfully completed. For example, a post-update message may say “Your software is successfully updated to the latest version,” and instructions to proceed to the next stage may be provided (e.g., “click ‘Close’”). A post-update message also may provide instructions to a user to re-insert a memory card, in the event that previous instructions to remove the memory card before performing the software update were provided. Additional post-update messages may provide instructions regarding reformatting the memory card and copying files back onto the memory card, in the event that the device cannot read the memory card after the software update process. Still other post-update messages may provide instructions to change location settings (e.g., from 911 only to Location ON) after the software update, and or to launch visual voicemail after the software update. According to an embodiment, log files may be transmitted from the client workstation to the enterprise server (for storage in the RSD database) in conjunction with each software update attempt.

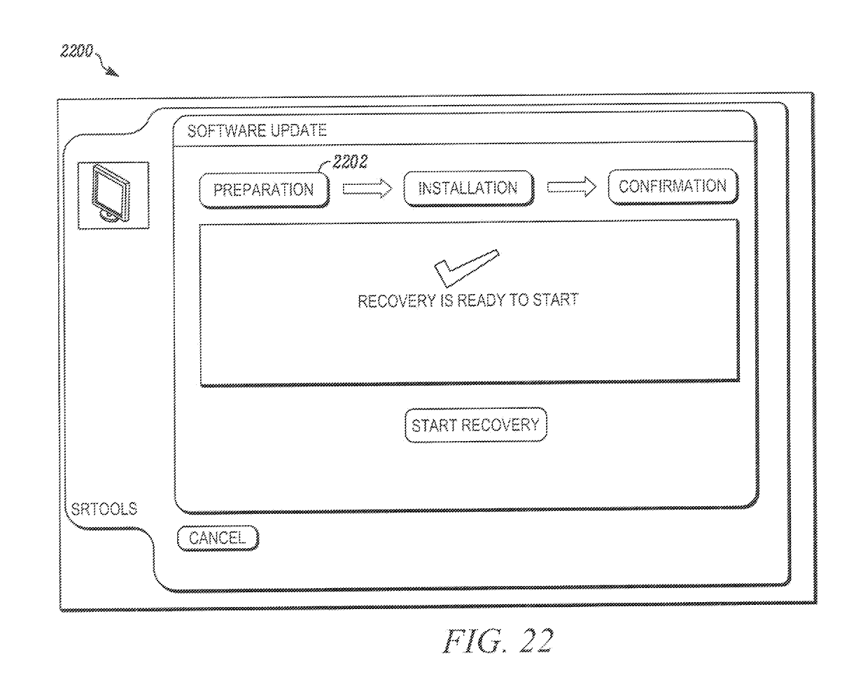

In cases in which a device does not power up properly, although there is sufficient charge, the device may be recovered by reinstalling the device software. For example, device recovery may be performed when a device is connected to the client workstation in flash mode. According to an embodiment, the browser may display a dialog for the user to manually select the phone model and carrier/operator, and to configure the device in a bootloader mode. The user may then indicate that the user would like to perform a software update (e.g., by selecting the “Update Software” icon 2104, FIG. 21) or by navigating to the software update screen. The user may then attempt to establish a connection between the client workstation and the device (e.g., by selecting an “Establish Connection” icon). When the system determines that the device is recoverable, the browser may display additional information. For example, FIG. 22 illustrates an example screen shot 2200 that may be presented on a client workstation in conjunction with a recovery process, in accordance with an example embodiment. In conjunction with a recovery process, a “Recovery is ready to start” message 2202 may be displayed.

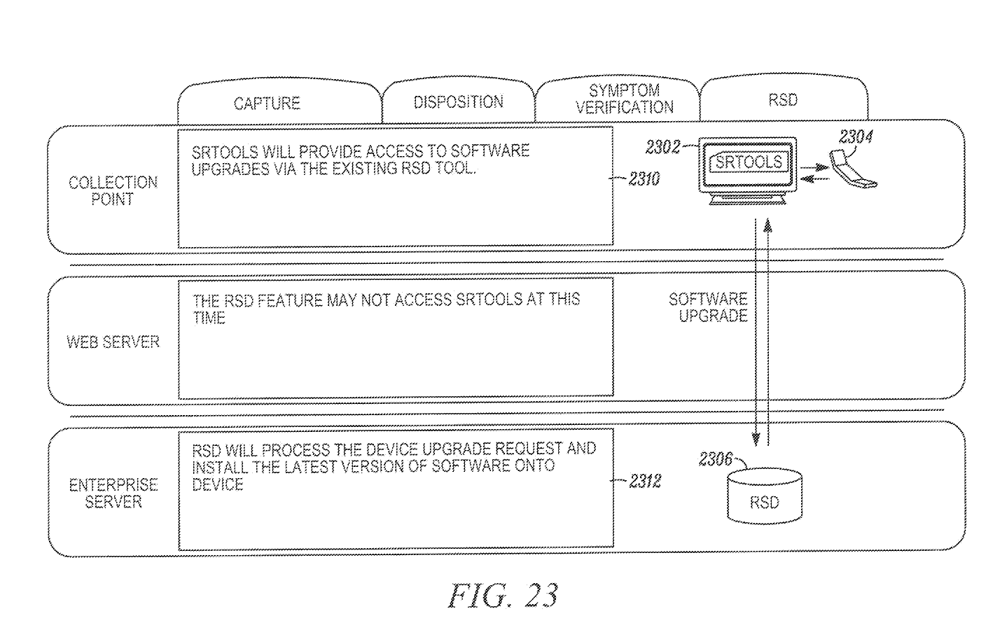

FIG. 23 is a conceptual diagram illustrating interaction between various system components (i.e., a client workstation or collection point 2302, a device 2304, and an RSD database 2306) in conjunction with a software update process, in accordance with an example embodiment. In step 2310, the SRTools application may provide access to the device 2304 to software upgrades via the RSD tool. For example, the client workstation 2302 may send a device software upgrade request to the enterprise server having access to the RSD database 2306. In step 2312, the RSD tool may process the request, and the latest (or some other) version of software may be installed on the device 2304.

According to an embodiment, a user may register with the system to receive software update information via email or text. The registration page may be displayed prior to performing a software update, prior to repair submission, and/or at other stages during the diagnostic procedure. The SRTools application may store user data that may be retrieved to populate a knowledge management database (e.g., FAQs in knowledge management database 142, FIG. 1), in an embodiment. Alternatively, the SRTools application may communicate with hosted forms, and a destination URL may be passed to allow the user to return to the software update process after successful registration. Alternatively, a separate registration window may be opened.

Referring again to FIG. 11 and block 1114, when a determination is made that a software update is not needed or after completion of the software update, a further determination is made, in block 1118, whether the reported problem was solved with the software update, or whether no problem was detected (e.g., during the triage process of block 1112). If so, then in block 1120, the user is notified of resolution of the problem or the absence of a problem, and the method ends.

When a determination is made that the reported problem was not solved with the software update and that an actual problem was detected, then in block 1122, a further determination is made whether another serviceable operational problem has been identified. When it is determined that the problem is not serviceable through interaction between the user, electronic device, and client workstation (possibly in conjunction also with the web server and/or enterprise server), then the system may provide the user with a prompt to indicate whether or not they would like to submit the device for repair. Prior to receiving the repair submission prompt, the SRTools application may call a repair management system (e.g., repair management system 152, FIG. 1) to retrieve information about the device and to determine which service programs are available for the user to consider.

When the user indicates that they would like to submit their device for repair, the system provides information to support shipping the electronic device to a repair facility for further diagnosis, repair, or replacement, in block 1124. This may include prompting the user to fill out a repair submission request form, providing the user with instructions regarding shipping (e.g., address, packaging, and so on), and/or prompting the user for additional information (e.g., return shipping information, credit card information, and so on). The system may pre-populate the repair submission request form (e.g., if the user provides an email address, the SRTools application may query a registration platform for information with which the application may pre-populate the form). The repair submission related information may be conveyed to the repair management system (e.g., in the form of a call t the repair management system).

This information may be used by the repair management system to create a repair request. During the process of creating a repair request, a unique service ID number (or repair identifier) may be assigned by the system to the repair request. According to an embodiment, the unique service ID number may be assigned by a repair tracking component of the system. A confirmation screen may display a printable summary of the repair request, including a tracking number assigned to the repair request. In addition, the SRTools application may allow the user to print a shipping label. A secure billing page may be displayed to facilitate collection of payment information, particularly for electronic devices that are out of warranty.

According to an embodiment, after requesting a repair, the system may enable the user to track the repair, for example, by making selections on a particular page (e.g., selecting a “Track My Repair” icon on a “Service My Product” page). The user may be able to enter the service ID number (or repair identifier), and the repair tracking component of the system will return the status and results of the repair for display, if found successfully. According to another embodiment, a user may be provided with access to repair histories of all devices submitted by the user for repair.

Upon receipt of the electronic device at the service facility, a service facility technician may access information previously entered into the system regarding the operational problem (e.g., information entered by the user regarding a description of the operational problem and information determined by the system during the diagnostic procedure, which may be stored and maintained in conjunction with a CRM database of a CRM system). In an embodiment, a claim automatically may be generated by a computing system of the service facility. This may include, for example, the computing system accessing the previously-entered information, and populating a claim form with the information. The service facility technician may access the claim form to obtain information regarding the operational issue. Typically, this process may result in the provision of substantially more information to the service facility technician than is provided using prior repair processes. Accordingly, the service facility technician may more quickly and efficiently execute repairs to the electronic device, and return the electronic device to the user.

When another serviceable operational problem has been identified, as determined in block 1122, a further determination is made, in block 1126, whether the problem may be remedied through provision of information (e.g., user education and/or instruction). If so, then in block 1128, the system provides the user with such education and/or instruction (e.g., by retrieving and providing step-by-step instructions to the user and/or by retrieving and providing relevant articles or instructions from a knowledge management system (e.g., implemented in conjunction with the enterprise server)). Some of the retrieved information may be selected by the system, in an embodiment, based on the customer model number captured in conjunction with block 1108, for example. In an alternate embodiment, the system need not perform the preceding method steps in order for the user to be provided access to the knowledge management system. Instead, the user may directly access the knowledge management system through selection of a knowledge management option (e.g., an icon) displayed by the GUI. The knowledge management system includes a knowledge management database (e.g., knowledge management database 142, FIG. 1, which may be an RNT (RightNow Technologies) database), according to an embodiment, which may store trouble shooting information (e.g., frequently asked questions (FAQs)) that may be accessible to the user. The information may be tagged by complaint category, relevant products (e.g., device models), and as troubleshooting, according to an embodiment. For example, the knowledge management system may provide FAQs that are contextual to the device selected by the user. The troubleshooter application may include a workflow based application that helps users diagnose device problems on their own through a series of FAQ documents.

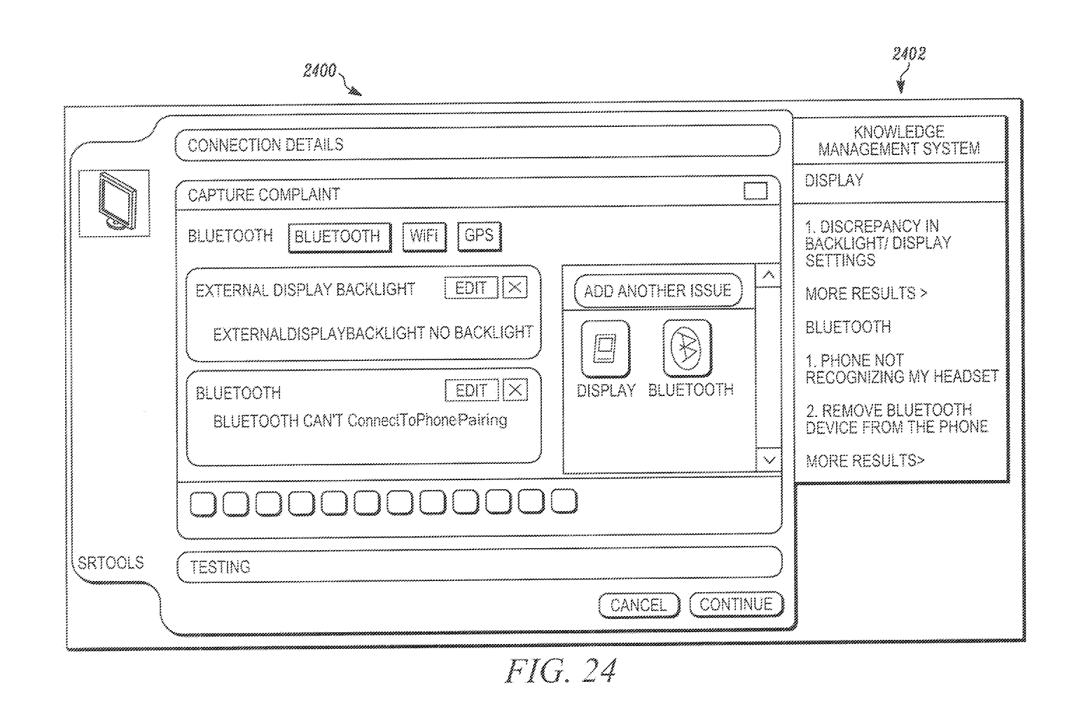

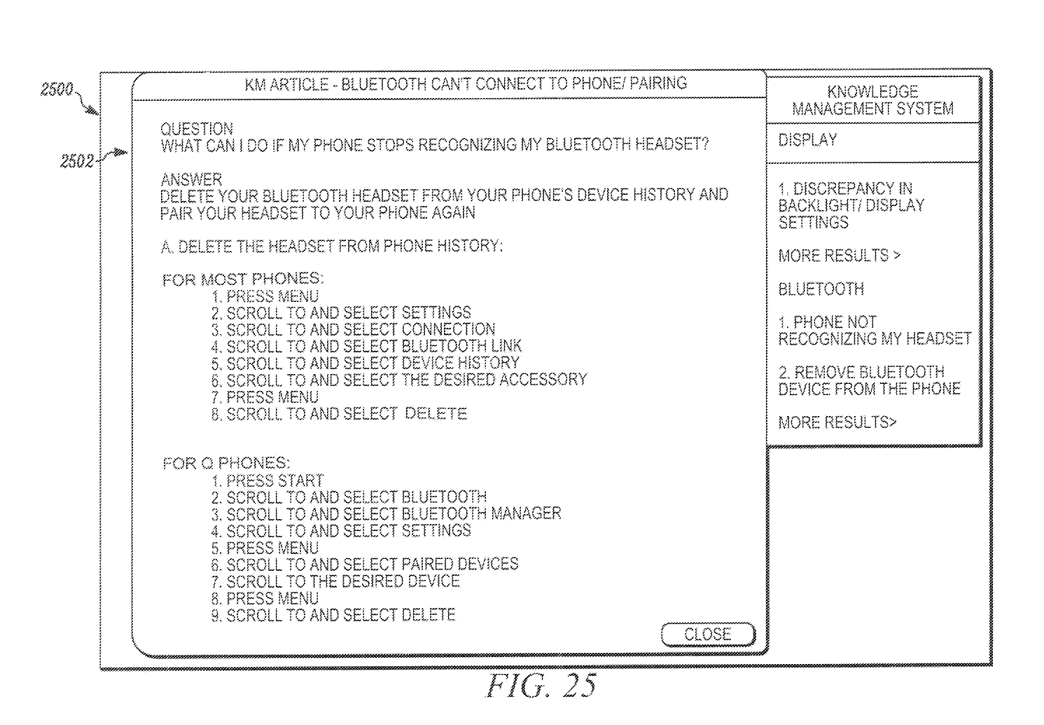

FIGS. 24 and 25 illustrate example screen shots 2400, 2500 that may be presented on a client workstation in conjunction with retrieving information from a knowledge management system, in accordance with an example embodiment. As FIG. 24 depicts, a page associated with the complaint capture or other process may include a list 2402 of articles available in the knowledge management system, where the list may be presented based on issues specified by the user. Upon selection of a particular article, in the list 2402, a page may be displayed that includes the text of the article 2502, as shown in FIG. 25.

Referring again to FIG. 11 and block 1128, after provision of the information to the user, the method may then end, or return to block 1118 to determine whether all problems have been resolved.

Referring again to blocks 1122 and 1126, when the other serviceable problem may not be remedied through provision of information, but the system is capable of resolving the problem, then a suitable, other remedy may be provided by the system, in block 1130. The method may then end, or return to block 1118 to determine whether all problems have been resolved.

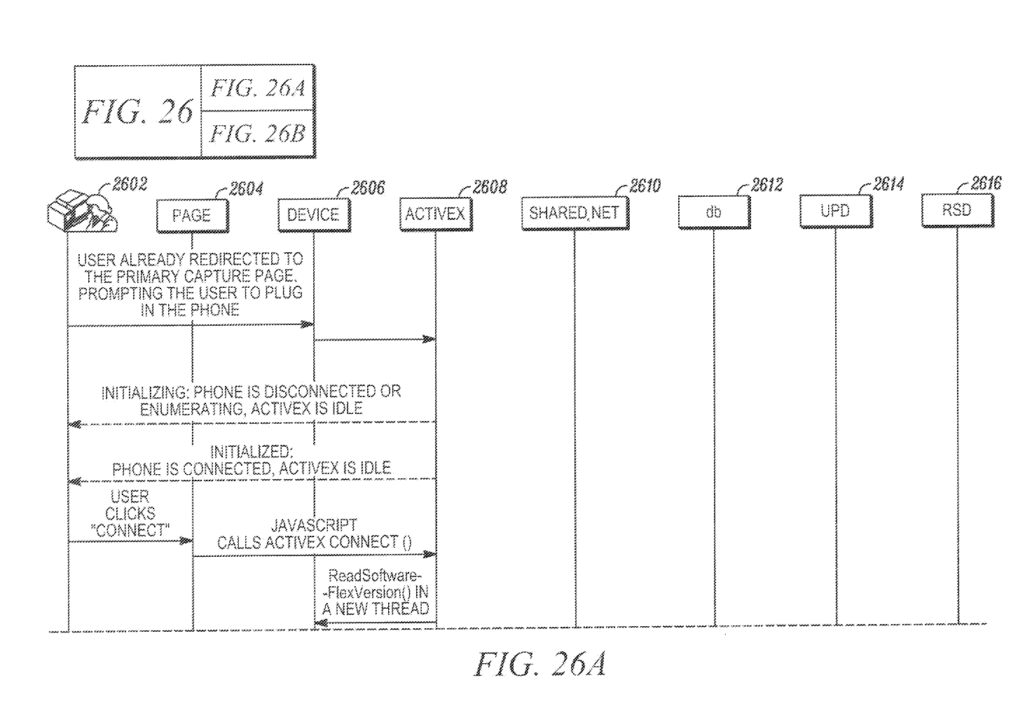

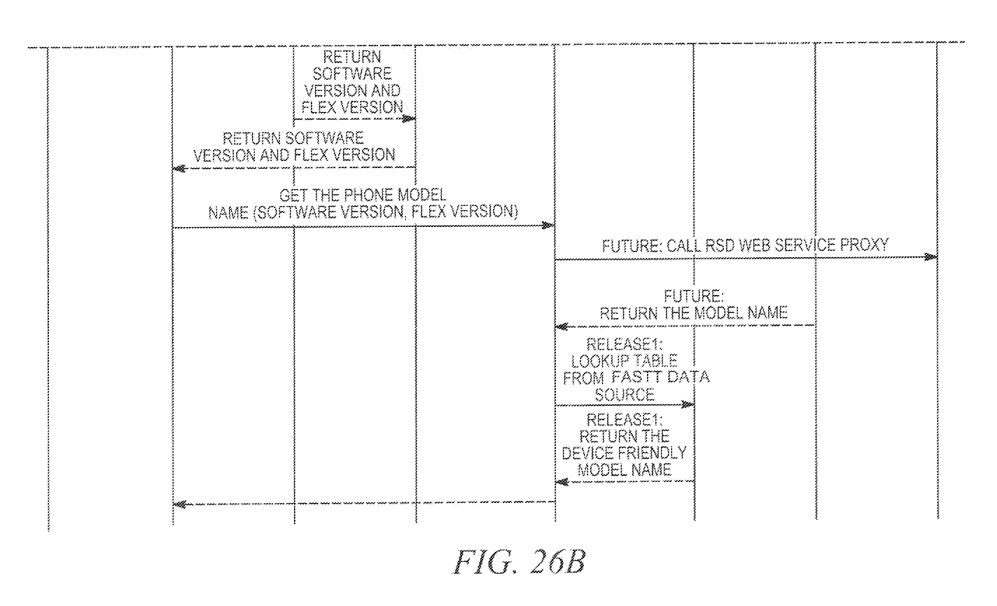

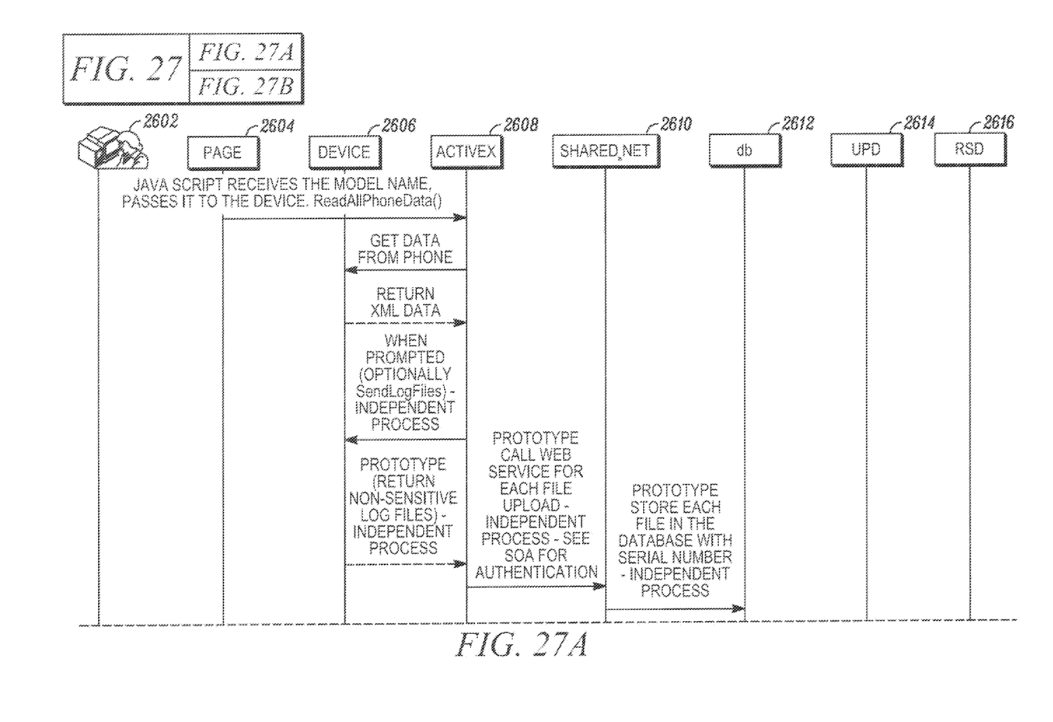

FIGS. 26-31 are sequence diagrams illustrating interaction between various system components in conjunction with various aspects of a diagnostic process, in accordance with an example embodiment. It is to be understood that the example embodiment discussed in conjunction with FIGS. 26-31 is not meant to be limiting, and that the sequence of processes depicted could be rearranged, additional processes could be performed, or some processes could be bypassed, in other embodiments. In addition, although references may be made to ActiveX components, JavaScript, and so on, other embodiments may use other types of code that can provide the same or similar functionality.

More specifically, FIGS. 26-31 illustrate various messages that may be exchanged, in response to inputs by a user 2602 at a client workstation, between a page 2604 being executed by a browser on the client workstation, an electronic device 2606, an ActiveX component 2608 configured as a bridge or integration point to native code on the client workstation, one or more servers 2610 (e.g., Shared .Net), an SRTools database (db) 2612, a UPD database 2614, and an RSD database 2616.

In FIG. 26, a user has been directed to a primary capture page, in which the user is being prompted to plug in a phone that the user desires to have the system diagnose. The ActiveX component 2608 is idle in an initializing state and an initialized state, when the phone is disconnected or enumerating, or when the phone is connected but prior to the user indicating that the user desires the system to establish the connection. When the user clicks “Connect”, JavaScript associated with the page may call may interact with native code on the client device via the ActiveX component 2608, and the ActiveX component 2608 may then read the device Flex and software version from the device 2606. The ActiveX component 2608 may then return the device Flex and software version to the page.

Thereafter, the page may attempt to get the phone model name from a server 2610 by passing the server the device Flex and the software version. The server may call a web service proxy associated with the RSD database 2616, and the model name may be returned. Alternatively, the server may access a FASST device software table on the SRTools database 2612 to attempt to identify the software configuration on the phone, which specifies the “market” or “device friendly” model name. Either way, the model name is returned by the server 2610 to the page 2604 on the client device.

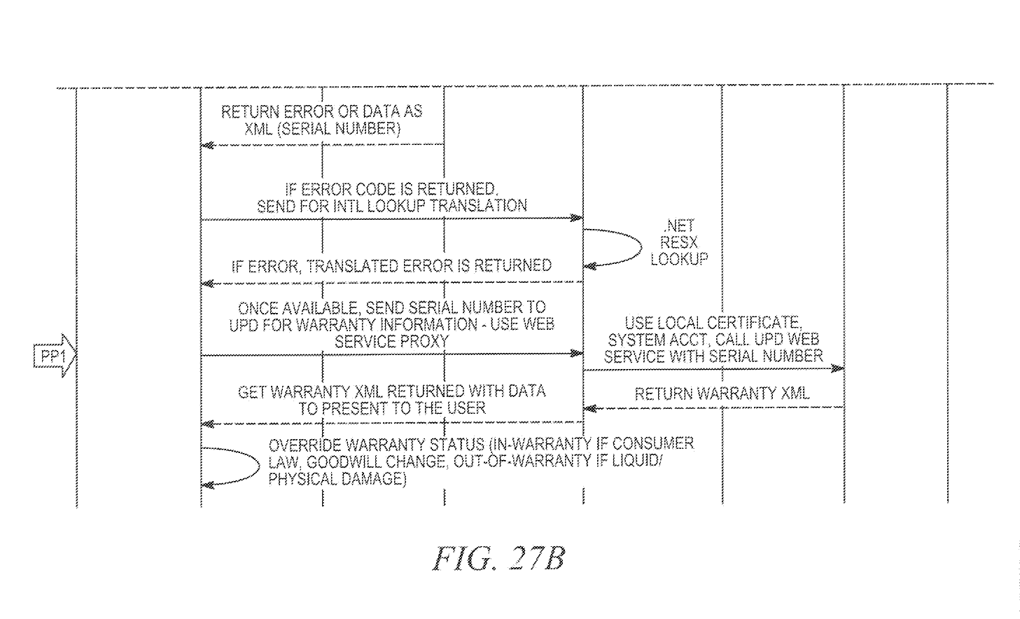

Referring now to FIG. 27, the process may continue when JavaScript associated with the page receives the model name. Based on the model name, the ActiveX component 2608 may read various device data from the phone (e.g., device-specific information, including the device serial number). The phone may return the device-specific data via the ActiveX control to the page in extensible markup language (xml) or another format. The serial number may then be sent to server 2610 as a key to look up warranty information for the device in the UPD database 2614. More specifically, the server 2610 may call a UPD web service with the serial number, and the warranty data (e.g., warranty status and other warranty-related information) may be returned to the server 2610 (e.g., in xml format). The server 2610, in turn, provides the warranty data to the page 2604. When the warranty status is returned as out of warranty or unknown, the system may disallow the user from accessing various functions of the diagnostic process (e.g., software update). According to an embodiment, however, a user may override the warranty status returned to the page 2604, thus enabling the user to access desired functions.

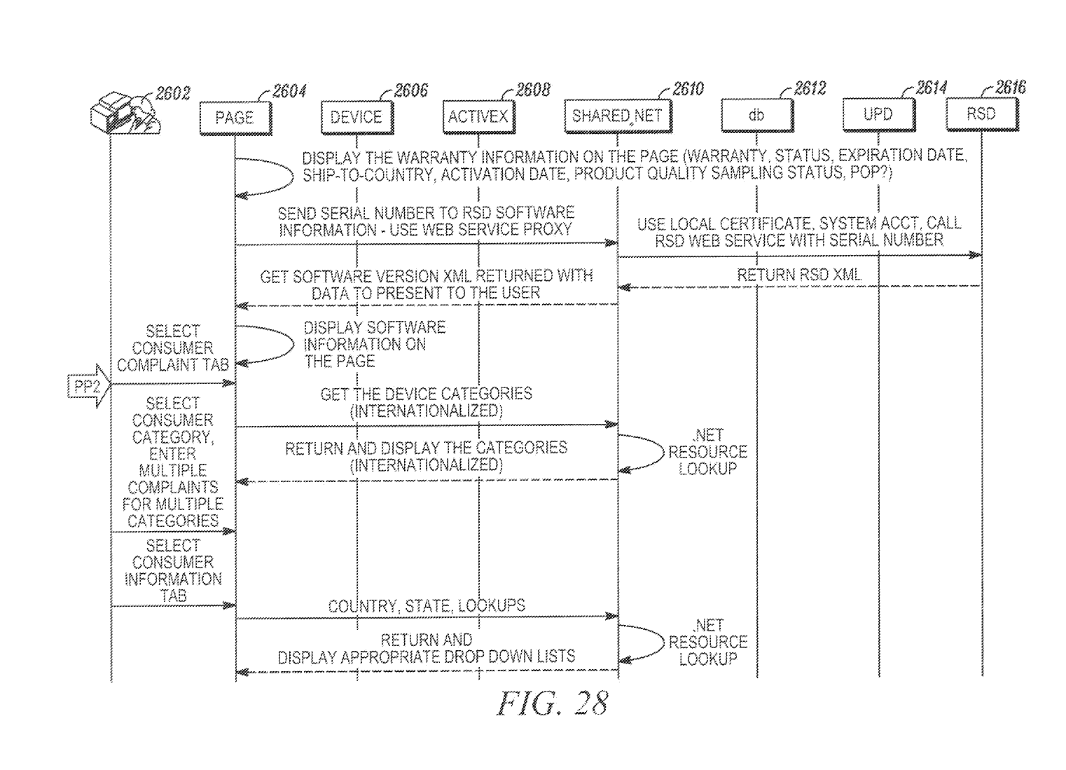

Referring now to FIG. 28, the process may continue when the client workstation displays the warranty information on the page 2604. When the device is in warranty (or the warranty was overridden), the page 2604 sends the serial number to server 2610, which may call an RSD web service with the serial number to access the software status from the RSD database 2616. The software status is returned from the RSD database 2616 to the page (e.g., in xml format) via the server 2610. The software status may then be displayed on the page 2604.

When the user indicates that the user would like to enter a consumer complaint (e.g., by selecting the “Consumer complaint” tab), the page 2604 may retrieve device categories from the server 2610. The server 2610 may then return the device categories to the page 2604 for display in the form of icons, drop-down lists, text, and so on.

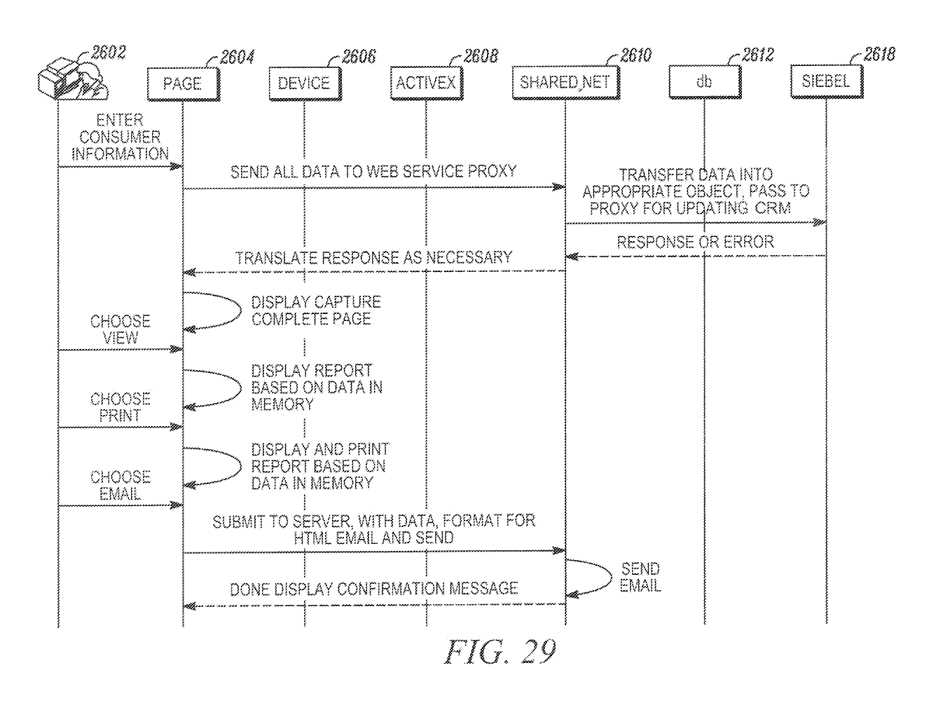

Referring now to FIG. 29, the process may continue when the user enters additional consumer information by selecting one or more consumer categories, one or more sub-categories, and one or more issues within each sub-category. The page 2604 sends data representing the user selections to the server 2610, when translates the data into an appropriate object, and passes the object to a CRM system 2618 (e.g., the Siebel CRM system by Oracle) for creation of a consumer case. The CRM system 2618 may return a response or error, as appropriate, to the server 2610, which may translate and forward the response or error to the page 2604 for display to the user. The user may thereafter choose to view, print, or email a report associated with entry and submission of the consumer complaint, essentially ending the consumer complaint entry process.

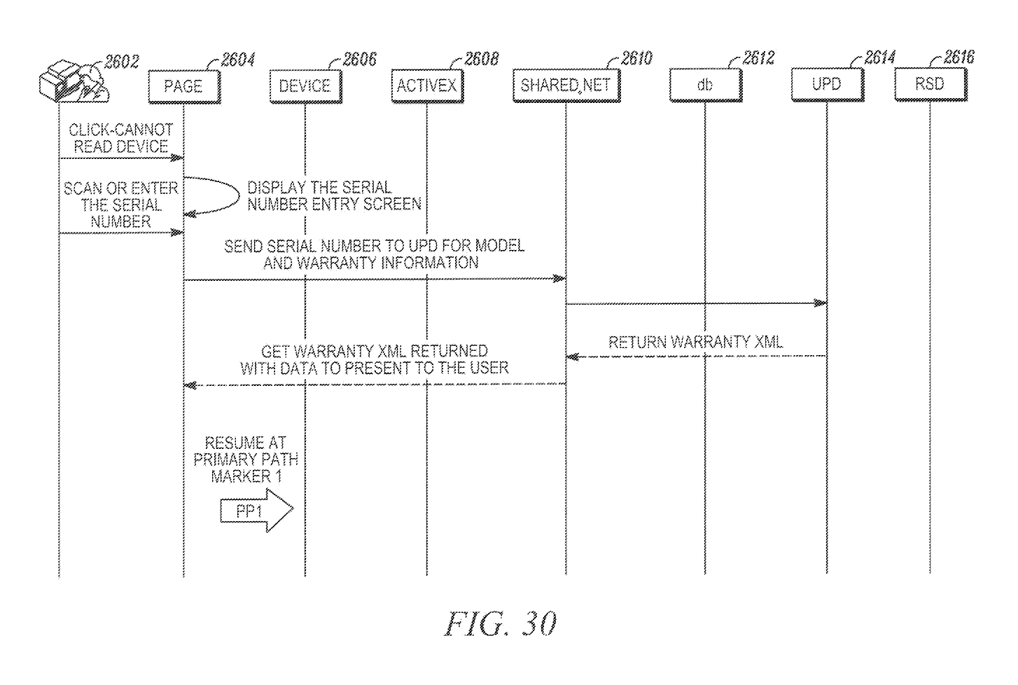

In some cases, at the beginning of the process, the client workstation may not be able to read the serial number from the device, either because the device is not connected or for some other reason. Referring now to FIG. 30, the user may be given the option on the page 2604 to enter the serial number manually or to scan the serial number. When the user does so, the page 2604 may send the serial number to the server 2610 as a key to look up warranty information for the device in the UPD database 2614, as described previously in conjunction with FIG. 27. The warranty data (e.g., warranty status and other warranty-related information) may be returned to the server 2610 which, in turn, provides the warranty data to the page 2604. The process may then proceed at primary path marker 1 (PP1), FIG. 27, as previously described.

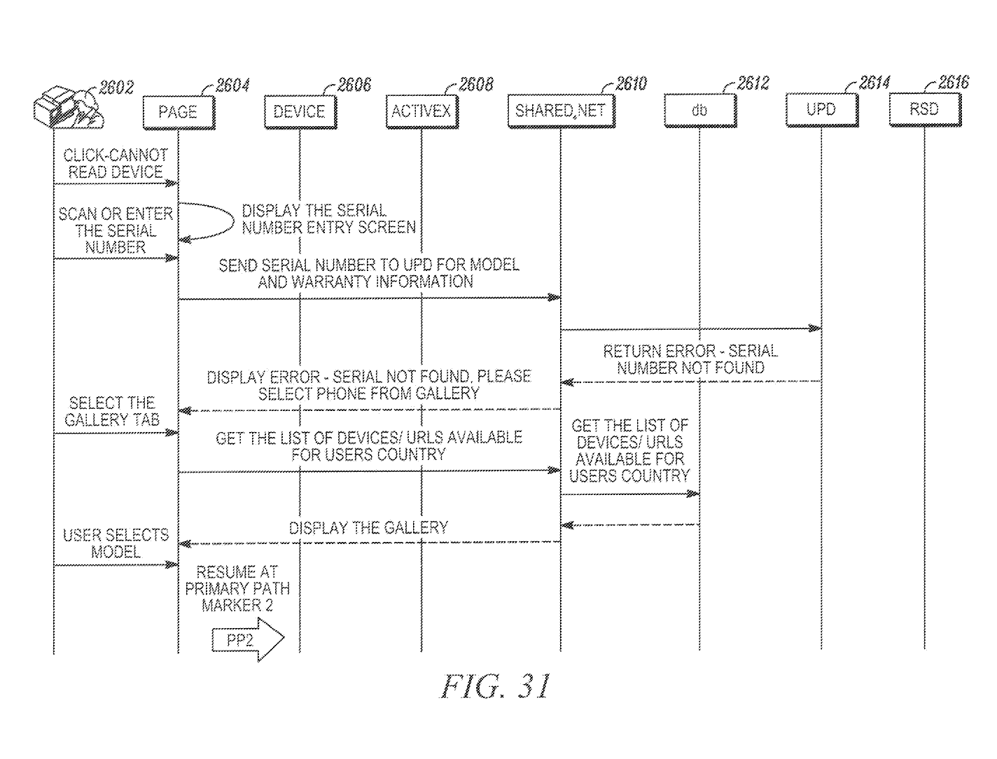

Referring now to FIG. 31, in an alternate scenario, after the user has scanned and entered the serial number, and the serial number has been sent by the page 2604 to the server 2610 for lookup in the UPD database 2614, the UPD database 2614 may return an indication to the server 2610 that the serial number was not found. In that case, the server 2610 may provide an indication to the page 2604 that the serial number was not found, and the page 2604 may prompt the user to select the device from a gallery, model carousel, or other representation of a plurality of device models. When the user indicates that the user would like to select the model, the page 2604 may sent a request to the server 2610 for a list of available devices/URLs (e.g., for the user's country). The server 2610 may obtain this list, for example, from the SRTools database 2612, and may return the list to the page 2604 for display in gallery or other format. The process may then proceed at primary path marker 2 (PP2), FIG. 28, as previously described.

Thus, various embodiments of methods and apparatus for performing diagnostic procedures on electronic devices have been described. Implementation of the embodiments within a service and repair business model provides a seamless and intuitive end-to-end experience throughout each step of an electronic device service process. More particularly, various embodiments provide an integrated and holistic set of diagnosis, service, and repair functionalities with an intuitive user interface that aligns various types of service touchpoints.

The various embodiments provide software update, functional testing, and integration toolkit functionalities in the context of a service and repair business model. For example, the software update features enable new software versions (e.g., carrier/operator software) readily to be downloaded into an electronic device. In addition, the system may provide for various user information to be backed up and restored, when needed. Functional testing features (e.g., diagnostic features) enable core functional tests easily to be performed on an electronic device through interaction between the device, the client workstation, and the web and enterprise servers. Further, the various functional tests may be identified and initiated via user interaction with an intuitive user interface at the client workstation. Finally, the configuration of the diagnostic system is such that the system's functionality may be seamlessly accessed by existing repair systems (e.g., existing carrier/operator and service center repair systems). Embodiments of the system enable information readily to be exchanged between the diagnostic system and other carrier/operator service center systems.

Embodiments of the diagnostic system described herein provide users with access to a variety of features involving a direct connection to an electronic device from the initial consumer interaction all the way through post-repair processes. In addition to providing diagnostics information and software updates, embodiments of the diagnostic system may enable a service network to perform a variety of other functions including, but not limited to, validating the presence of a device in the service network; determining the routing of a device in the service network based on a consumer's complaint; determining the routing of a device based on preliminary screening tests; identifying the recommended repair actions necessary to return the device to a fully functional state; and verifying the completeness of a repair.

The SRTools application may be integrated into a larger enterprise suite of applications. Embodiments of the application may be designed to be flexible and dynamic in nature in their design and interaction with their users. In addition, the SRTools application is configured to operate in a lean, efficient, timely, and relevant manner, and to empower users to make consistent and accurate decisions regarding operational issue identification, resolution, and repair.

Embodiments of the SRTools application provide browser-based connectivity to USB devices. A particular embodiment provides this connectivity using a web browser executing on a client work station, in which JavaScript is used to formulate and perform computations and to initiate communications with the electronic device through a messaging bridge (e.g., an ActiveX control) to native code executing on a client workstation. This enables the client workstation to connect to and read from devices connected to the client workstation directly from the web browser. In addition, embodiments provide an ability to capture consumer information and consumer device complaints. Integration with a variety of systems (e.g., web services) enables the SRTools application to check device authenticity, warranty status, software status, and to provide a direct tie-in to a CRM system to store and manage consumer and consumer complaint information.

An embodiment includes a method of evaluating a wireless communication device using a computing system are provided. The method includes establishing a data connection between the wireless communication device and the computing system, and receiving device-specific information associated with the wireless communication device. The device-specific information includes at least one identifier associated with the wireless communication device. The device-specific information is provided to a server over a network, and additional device-specific information associated with evaluating the wireless communication device is received in response to providing the device-specific information to the server. Finally, in response to receiving the additional device-specific information, diagnostic-related information and a representation of the additional device-specific information are displayed on the computing system.

As described previously, “device-specific information” that the client workstation receives from the device over the data connection includes information that is stored on the device such as, but is not limited to any one or more of device model information, the activation date, software versions, the device Flex, the baseband ID, the keypad lockcode, and the serial number. As also described previously, “additional device-specific information” from the servers that the client workstation receives in response to the client workstation sending some or all of the device-specific information to one or more servers includes, but is not limited to, any one or more of software configuration information (e.g., configuration ID, model number, model name, product, and family), a device model name, a device model number, software customer name, warranty status, software update status, authenticity result, shipment information (e.g., ship date, ship to customer name), manufacturing information (e.g., manufacturing date, factory/distribution location), warranty expiration date, warranty coverage periods, warranty coverage type, warranty renewal information, repair history (e.g., last repair date, repair count, lifetime airtime timer, activation date), and software information (e.g., software version, Flex version, software carrier/operator, software update status). “Diagnostic-related information” includes, but is not limited to, any one or more of an identification of model-specific triage tests, an identification of carrier/operator-specific triage tests, an indication of whether or not software updates are available, release notes, articles, instructions, and troubleshooting information.

Another embodiment includes a method of diagnosing a portable wireless communication device using an intermediary browser executed on a computing system. The method is performed by the browser and includes receiving, from a server, a web page including code to query the wireless communication device for device information over a data connection between the wireless communication device and the computing system, communicating with the web page to receive the device information, including at least one device identifier associated with the wireless communication device, sending the at least one device identifier to the server, and receiving from the server, in response to sending the at least one device identifier, information indicating one or more test routines to test one or more functionalities of the wireless communication device.

Yet another embodiment includes a method of evaluating a wireless communication device using a computing system, where the computing system is physically distinct from the wireless communication device. The method is performed by the computing system and includes establishing a USB data connection between the wireless communication device and the computing system, receiving device information associated with the wireless communication device, wherein the device information includes at least one identifier associated with the wireless communication device, and providing the device information to a server over a network. In response to providing the device information to the server, additional device information associated with the wireless communication device is received from the server, and displaying the additional device information and diagnostic-related information are displayed.

Various ones of the figures include example screen shots, which are discussed throughout the detailed description. Although each illustrated screen shot depicts various windows, icons, menus, specific text, select buttons, and other displayed page components, it is to be understood that the particular page components and their relative arrangements are provided for example purposes only. It is to be understood that the various system functionalities may be accessed and depicted using pages having more, fewer, and/or differently arranged page components.

As used herein, numerical ordinals such as “first,” “second,” “third,” and so on, simply denote different singles of a plurality and do not imply any order or sequence unless specifically stated otherwise. Furthermore, words such as “connected” or “coupled to” used in describing a relationship between different elements do not imply that a direct physical connection must be made between these elements. For example, two elements may be connected to each other physically, electronically, logically, or in any other manner, through one or more additional elements, without departing from the scope of the inventive subject matter.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the inventive subject matter.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter, it being understood that various changes may be made in the function and arrangement of elements described in an exemplary embodiment without departing from the scope of the inventive subject matter as set forth herein.

1. A method of evaluating a wireless communication device using a computing system, wherein the computing system is physically distinct from the wireless communication device, the method performed by the computing system and comprising:
establishing a data connection between the wireless communication device and the computing system;
receiving device-specific information associated with the wireless communication device, wherein the device-specific information includes at least one identifier associated with the wireless communication device;
providing the device-specific information to a server over a network;
receiving, from the server in response to providing the device-specific information to the server, additional device-specific information associated with evaluating the wireless communication device; and
displaying, on the computing system in response to receiving the additional device-specific information, diagnostic-related information and a representation of the additional device-specific information.

2. The method of claim 1, further comprising:
evaluating the wireless communication device using the additional device-specific information.

3. The method of claim 1, further comprising:
receiving, based on user inputs to the computing system, an indication of one or more issues relating to operating the wireless communication device; and
displaying, on the computing system in response to receiving the indication, device test-related information that indicates at least one diagnostic test that the computing system may perform on the wireless communication device.

4. The method of claim 1, further comprising:
receiving, based on additional user inputs to the computing system, an identification of at least one selected test of the at least one diagnostic test that the user would like the computing system to perform;
performing the at least one selected test on the wireless communication device; and
displaying results of the at least one selected test.

5. The method of claim 1, wherein establishing the data connection comprises establishing the data connection as a Universal Serial Bus (USB) data connection between the wireless communication device and the computing system.

6. The method of claim 1, further comprising:
executing a browser on the computing system, wherein the browser is configured to display at least one page that includes an object configured to instruct native code on the computing system to communicate with the wireless communication device.

7. The method of claim 6, wherein the object comprises a bridge to the native code.

8. The method of claim 1, wherein receiving the device-specific information comprises receiving a serial number of the wireless communication device.

9. The method of claim 8, wherein receiving the device-specific information comprises receiving the serial number via the data connection between the wireless communication device and the computing system.

10. The method of claim 8, wherein receiving the device-specific information comprises receiving the serial number as a value that is manually entered by a user of the computing system via a user interface.

11. The method of claim 8, wherein providing the device-specific information to the server comprises providing the serial number to the server, and wherein the step of receiving the additional device-specific information comprises:
receiving, from the server, an indication of whether the wireless communication device is in warranty or out of warranty based on the serial number.

12. The method of claim 11, further comprising:
displaying, on the computing system, the indication of whether the wireless communication device is in warranty or out of warranty;
when the wireless communication device is in warranty, determining whether a software update is available; and
when the software update is available, presenting a user of the computing system with an indication that that the software update is available and with an option to perform the software update.

13. The method of claim 1, wherein:
receiving the device-specific information comprises receiving, from the wireless communication device, information indicating a software configuration programmed into the wireless communication device;
providing the device-specific information comprises providing, to the server, the information indicating the software configuration; and
receiving the additional device-specific information comprises receiving, from the server, a device model in response to providing the information indicating the software configuration.

14. The method of claim 13, wherein receiving the device-specific information further comprises:
in response to receiving the device model, reading the at least one identifier from the wireless communication device over the data connection.

15. The method of claim 1, wherein receiving the device-specific information comprises receiving a software version from the wireless communication device.

16. The method of claim 15, further comprising:
when the software version indicates that a software update is available, presenting a user of the computing system with an indication that the software update is available and with an option to download the software update.

17. The method of claim 16, further comprising:
when the user provides user inputs to the computing system indicating a user selection of the option to download the software update, downloading the software update from the server, and installing the software update on the wireless communication device using the data connection.

18. The method of claim 1, wherein the step of receiving the additional device-specific information includes receiving information identifying diagnostic tests unique to the wireless communication device.

19. The method of claim 1, further comprising displaying, based on the at least one identifier and the additional device-specific information, queries to a user.

20. The method of claim 1, further comprising displaying icons that are selected based on the at least one identifier and the additional device-specific information.

21. The method of claim 1, further comprising:
receiving, from the server, information indicating a recommendation for a user that is determined based on the device-specific information; and
displaying an indication of the recommendation.

22. The method of claim 21, wherein the recommendation is based on a serial number of the wireless communication device, a carrier/operator, and a current software version.

23. The method of claim 1, further comprising:
performing one or more wireless communication device tests over the data connection; and
when at least one of the wireless communication device tests has failed, displaying information relating to sending the wireless communication device to a repair center for repairs.

24. A method of diagnosing a portable wireless communication device using an intermediary browser executed on a computing system, the method performed by the browser and comprising:
receiving, from a server, a web page including code to query the wireless communication device for device information over a data connection between the wireless communication device and the computing system;
communicating with the web page to receive the device information, including at least one device identifier associated with the wireless communication device;
sending the at least one device identifier to the server; and
receiving from the server, in response to sending the at least one device identifier, information indicating one or more test routines to test one or more functionalities of the wireless communication device.

25. The method of claim 24, further comprising:
querying a user of the computing system to identify complaints associated with the wireless communication device;
sending an indication of the complaints to the server;
receiving from the server, in response to sending the indication, the information indicating the one or more test routines; and
executing the test routines, which include communicating with the wireless communication device over the data connection.

26. A method of evaluating a wireless communication device using a computing system, wherein the computing system is physically distinct from the wireless communication device, the method performed by the computing system and comprising:
establishing a Universal Serial Bus (USB) data connection between the wireless communication device and the computing system;
receiving device information associated with the wireless communication device, wherein the device information includes at least one identifier associated with the wireless communication device;
providing the device information to a server over a network;
in response to providing the device information to the server, receiving additional device information associated with the wireless communication device from the server; and
displaying the additional device information and diagnostic-related information.

27. The method of claim 26, wherein the wireless communication device is a cellular telephone.

28. The method of claim 26, wherein receiving the device information comprises receiving a serial number of the wireless communication device.

29. The method of claim 28, wherein receiving the device information comprises receiving the serial number via the data connection between the wireless communication device and the computing system.

30. The method of claim 28, wherein receiving the device information comprises receiving the serial number as a value that is manually entered by a user of the computing system via a user interface.

31. The method of claim 28, wherein:
the step of providing the device information to the server comprises providing the serial number to the server;
the step of receiving additional device information from the server comprises receiving an indication of whether the wireless communication device is in warranty or out of warranty based on the serial number; and
the step of displaying the additional device information comprises displaying the indication of whether the wireless communication device is in warranty or out of warranty.

32. The method of claim 31, wherein, when the wireless communication device is in warranty, the method further comprises:
determining whether a software update is available; and
when the software update is available, presenting a user of the computing system with an indication that the software update is available and with an option to download the software update.

33. The method of claim 26, further comprising:
querying a user of the computing system to identify complaints associated with the wireless communication device;
sending an indication of the complaints to the server;
receiving from the server, in response to sending the indication, an indication of one or more test routines; and
executing the test routines, which include communicating with the wireless communication device over the data connection.

34. The method of claim 26, further comprising:
executing a browser on the computing system, wherein the browser is configured to display at least one page that includes an object configured to instruct native code on the computing system to communicate with the wireless communication device.
